(19) United States
(12) Patent Application Publication
(10) Pub. No.: US 2011/0191708 A1
(43) Pub. Date: Aug. 4, 2011

(54) SELECTION INTERFACE STRUCTURES, SYSTEMS AND METHODS

(75) Inventor: George William REED, Berkeley, CA (US)

(73) Assignee: TWP Inc., Berkeley, CA (US)

(21) Appl. No.: 13/084,269

(22) Filed: Apr. 11, 2011

Related U.S. Application Data
(63) Continuation-in-part of application No. 12/417,375, filed on Apr. 2, 2009, now Pat. No. 7,925,543.
Application No. 12/417,375 is a continuation of application No. 11/692,817, filed on Mar. 28, 2007, now Pat. No. 7,533,041.
Application No. 11/692,817 is a continuation of application No. 10/357,803, filed on Feb. 3, 2003, now Pat. No. 7,207,013.
Application No. 10/357,803 is a continuation of application No. 09/507,474, filed on Feb. 17, 2000, now Pat. No. 6,552,739.

(51) Int. Cl. G06F 3/048

(52) U.S. Cl. 715/765

(57) ABSTRACT

Enhanced user selection interface structures comprise one or more buttons that are linked to selectable characteristics, and a display linked to the buttons, for display of an item that corresponds to the selected characteristics. The interface is typically linked to a database comprising stored images and other information that corresponds to the selectable characteristics, wherein an image that corresponds to an item that meets a selected characteristic is retrieved and displayed. Corresponding information other than the image may also be retrieved and displayed. In some embodiments, the stored images comprise a single image that matches all the selected characteristics. In alternate embodiments, the displayed image comprises a composite image that corresponds to different selected characteristics. In some embodiments, the user selection interface comprises any of a graphic user interface or a mechanical interface. Some preferred interface embodiments provide links for merchandising functions, such as for ordering, purchasing, inventories, and/or shipping.

### CROSS REFERENCE TO RELATED APPLICATIONS

This Application is a Continuation-in-Part and claims priority to U.S. patent application Ser. No. 12/417,375 entitled Product Characteristic Selection Website, filed 2 Apr. 2009, which is a continuation of U.S. patent application Ser. No. 11/692,817, entitled Wire-Mesh Selection Internet Website, filed 28 Mar. 2007, issued as U.S. Pat. No. 7,533,041 on 12 May 2009, which is a continuation of U.S. patent application Ser. No. 10/357,803, entitled Wire-Mesh Selection Internet Website, filed 3 Feb. 2003, issued as U.S. Pat. No. 7,207,013 on 17 Apr. 2007, which is a continuation of U.S. patent application Ser. No. 09/507,474, filed 17 Feb. 2000, entitled Wire-Mesh Selection Internet Website, issued as U.S. Pat. No. 6,552,739 on 22 Apr. 2003, each of which is incorporated herein in its entirety by this reference thereto.

### BACKGROUND OF THE INVENTION

1. Technical Field

The invention relates to selection interfaces, such as for Internet websites, and more specifically to selection interfaces and structures that allow a user to browse through and select from all available types of items, such as products.

2. Description of the Prior Art

The selection of products, parts, commodities, or other selectable items is commonly a laborious and time-consuming process, whereby a user or shopper is required to navigate and sort through numerous items that do not even remotely meet the user's requirements. For example, on a merchandising system implemented on a computer, e.g. through an Internet website, while a user may have an indication of one or more desired features of an item, the user is required to navigate through a large array of products, typically presented as lists of one or more items in a category. If a product name or brief description sounds remotely feasible, the user is then typically required to navigate to more detailed information regarding the item.

While graphic user interfaces and selection devices have provided basic means for selection for various devices, there is presently no interface and/or device that provides an integrated selection and display interface, whereby a user can quickly search, sort, and/or select. The development of such a system would be a major technological advance. Furthermore, there is currently no interface and/or selection device which provides an integrated selection and display interface, whereby a user can select and gain access to an image or other information related to a generic, i.e. available item/class of items having multiple properties, by which a most nearly matching item is selected from a universe of such items. The development of such a system would be a further technological advance.

### SUMMARY OF THE INVENTION

An enhanced user selection interface system comprises one or more button selectors linked to selectable characteristics, and a display linked to the selectors, for display of an image that corresponds to the selected characteristics. The interface is typically linked to a database comprising stored image and other information that corresponds to the selectable characteristics, whereby an image that corresponds to an item that meets a selected characteristic is retrieved and displayed. Information other than the image that corresponds to the selectable characteristics may also be retrieved and displayed. In some embodiments, the stored images comprise a single image, which matches all the selected characteristics. In alternate embodiments, the displayed image comprises a composite image that is based upon stored images that correspond to different selected characteristics. In some embodiments, the user selection interface comprises a graphic user interface. In alternate embodiments, the user selection interface comprises a mechanical interface. Some preferred embodiments of the user selection interface provide links for merchandising functions, such as for ordering, purchasing, inventories, and/or shipping.

### BRIEF DESCRIPTION OF THE DRAWINGS

FIG. 1 is a functional block diagram of an Internet wire-mesh merchandising system embodiment of the present invention;

FIG. 2 is a diagram of a graphical user interface for an HTML product page as it presents on a web browser operated by a user at a network client site;

FIG. 3 is a flow diagram that represents the navigation that occurs between HTML product pages as a result of a user clicking on any of four hyperlink buttons for finer, coarser, thicker, and thinner;

FIG. 4 is a diagram that represents a design form for a HTML product page, e.g. for a “004X004G035” wire-mesh product, and such is used by a webpage designer as a tool for HTML coding;

FIG. 5 is a diagram that represents a design form for a HTML product page, e.g. for a “008X008G017” wire-mesh product, and such is used as a tool for HTML coding;

FIG. 6 is a diagram that represents a design form for a HTML product page, e.g. for a “002X002D041” wire-mesh product, and such is used as a tool for HTML coding;

FIG. 7 is a diagram that represents a design form for a HTML product page, e.g. for a “004X004D025” wire-mesh product, and such is used as a tool for HTML coding;

FIG. 8 is a detailed schematic view of a button and display selection interface;

FIG. 9 is a detailed schematic view of an alternate button and display interface for selection of an exemplary wire mesh product;

FIG. 10 is a functional block diagram of a selection interface system comprising storage, navigation, and display of items matching selected criteria;

FIG. 11 is a perspective view of selectable nodes on a plurality of selection axes;

FIG. 12 is a schematic view of a stand-alone selection interface;

FIG. 13 is a schematic view that shows an exemplary front end and back end for a selective interface system having button navigation;

FIG. 14 shows an exemplary button that may preferably provide time-dependent interaction, e.g. rapid fire or repeat;

FIG. 15 shows an exemplary button that selects what a secondary button selects;

FIG. 16 shows an exemplary button that tilts to advance more than one direction, wherein a single button may be used for control of one or more selections;

FIG. 17 shows an exemplary button that fills and empties;

FIG. 18 shows an exemplary button that provides interactive display of activation, such as deformation, and may preferably provide pressure sensitive selection and/or control;

FIG. 19 shows the use of two or more buttons, such as for complex selection of one feature, or simultaneous selection of a plurality of features;

FIG. 20 shows an exemplary button that grays out or disappears at the end of choices, and one or more buttons that appear if a selectable choice becomes available;

FIG. 21 shows exemplary buttons that may be rearranged, joined, and/or split;

FIG. 22 shows a button that has a characteristic movement, e.g. throbbing or vibration, and a related feature, i.e. a connected characteristic, that has a related characteristic movement, to indicate a connection or selection relationship between the button and the feature;

FIG. 23 shows an interface wherein each button adds to or edits at least a portion of an image;

FIG. 24 shows a button wherein a number of clicks shows on or near button;

FIG. 25 shows a button having an appearance that corresponds to a selectable or selected characteristic;

FIG. 26 shows a button having a displayable text label that corresponds to a chosen feature;

FIG. 27 shows a button interface having one or more feature designation buttons that designate the current function of the selection buttons;

FIG. 28 shows buttons in which an available range is applied;

FIG. 29 shows a button interface in which a primary button is pushed to change the picture, and wherein a characteristic that was replaced moves to a secondary button;

FIG. 30 shows a button selection interface for sound control and/or editing, such as to control the duration, pitch or voice of one or more musical notes:

FIG. 31 shows a button selection interface, wherein a plurality of button choices are displayed outside the display area, such as for hierarchical selection of product groups;

FIG. 32 shows a schematic view of a selection interface system, wherein at least two of feature selectors are joined together by a relationship;

FIG. 33 shows a schematic view of a selection interface system, wherein one or more feature selector buttons may preferably provide fine tuning;

FIG. 34 shows a button interface having animated addition of attributes to a display area;

FIG. 35 shows an image interface having direct button control for a series of images;

FIG. 36 shows a process for assignment and/or control of features for a selection interface system having arrow navigation;

FIG. 37 shows a selective interface system having a plurality of sets of feature selectors, wherein each set of feature selectors has an associated image window;

FIG. 38 is s schematic diagram that shows how information from a selective interface system can be sent to another device, such as to another selective interface system;

FIG. 39 is a partial cutaway view of a feature selector buttons for a selective interface system, wherein an image further comprises touch sensitivity;

FIG. 40 is a schematic view of a selection interface system, wherein an image or video output associated with one or more selector buttons may preferably be further connected to a process or task;

FIG. 41 is a schematic view of an alternate embodiment of a selection interface system, wherein multiple selection interfaces may preferably be synchronized, such that different versions of a resultant image may be saved;

FIG. 42 is a schematic view of an alternate embodiment of a selection interface system, wherein one or more feature selectors may control the characteristics of a typeface or font, the characteristics of one or more passages of text, or default styles that can later be selected by a user;

FIG. 43 is a schematic view of an alternate embodiment of a selection interface system, wherein one or more feature selectors control the properties, selection and/or arrangement of objects or articles in space, and/or relationships between objects;

FIG. 44 is a schematic view of an alternate embodiment of a selection interface system, wherein one or more feature selectors control the selectable characteristics of a portion of text;

FIG. 45 is a schematic view of an alternate embodiment of a selection interface system, wherein one or more feature selectors control the selectable characteristics of variable parts of a mathematical equation;

FIG. 46 is a schematic view of an alternate embodiment of a selection interface system, wherein one or more feature selectors control the selectable characteristics of a waveform;

FIG. 47 is a schematic view of a selection interface system, wherein one or more feature selectors select, control, and/or determine a set of matchable characteristics;

FIG. 48 is a schematic view of an alternate embodiment of a selection interface system, wherein one or more feature selectors select, control, and/or modify colors;

FIG. 49 is a schematic view a selection interface system, wherein one or more feature button selectors may preferably be used to select size, such as for selection of a specified size of an object, or for selection of a specific object from a variety of objects having different possible sizes;

FIG. 50 is a schematic view a selection interface system having embedded button selectors;

FIG. 51 is a schematic view of a selection interface system, wherein a hierarchy may be established between feature button selectors; and

FIG. 52 is a schematic view of a cascading selection interface having a plurality of button selection interfaces, wherein each of the sets of button selectors have an identical image, and wherein each set of buttons controls a single characteristic in all of the images.

### DETAILED DESCRIPTION OF THE INVENTION

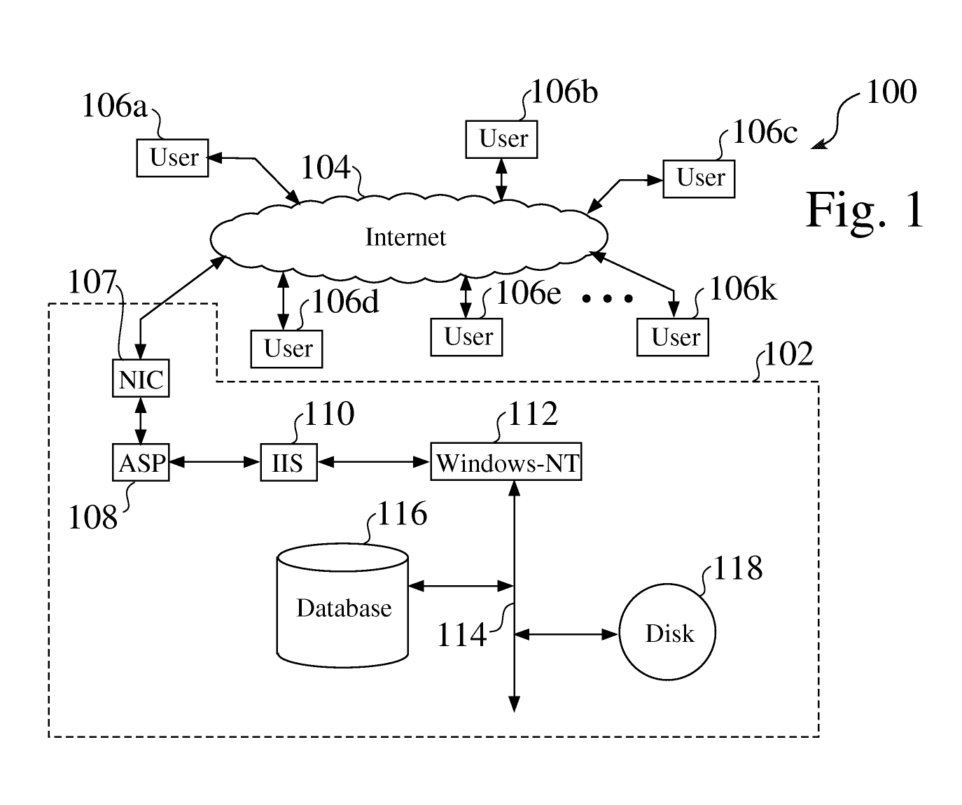

FIG. 1 illustrates an Internet wire-mesh merchandising system embodiment of the present invention, referred to herein by the reference numeral 100. The system 100 comprises a webserver 102 connected to the Internet 104 and many clients or shoppers 106a-106k. The webserver 102 interfaces to the Internet 104 with a network interface controller (NIC) 107. An interactive webpage user interface 108 provides functionality similar to Microsoft Corporation (Redmond, Wash.) Active Server Pages (ASP). An Internet file and application server 110, such as Microsoft Internet Information Server (IiS), runs under control of an operating system 112, e.g. Microsoft Windows-NT server. The ASP 108 and IiS 110 together generate a web presence on the Internet. An expansion bus 114 supports a database 116 and a general purpose storage disk 118. Various Microsoft Windows-NT services can run without requiring a user to be logged on to the system, e.g. Microsoft SOL Server, Microsoft Exchange Server, Dynamic Host Interface Protocol (DHCP), and even Windows Internet Name Service (WINS) servers. These are preferably stored in disk 118.

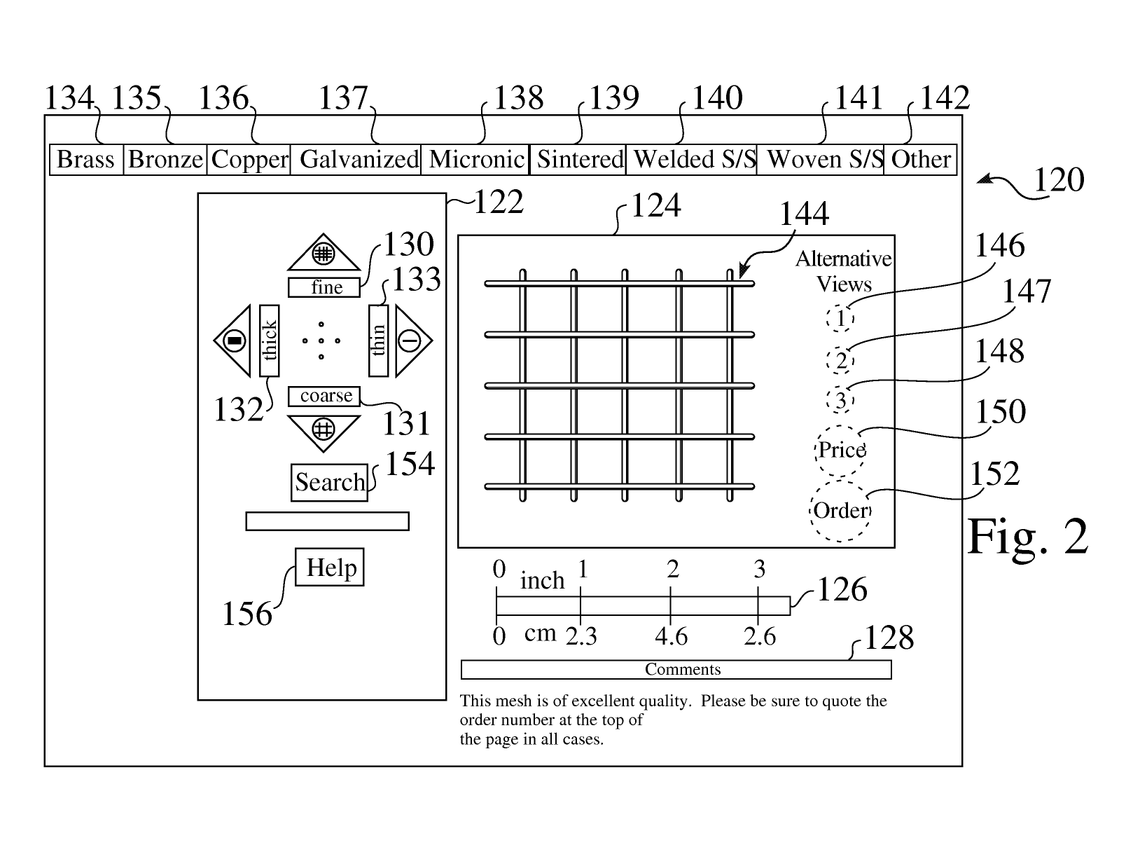

FIG. 2 represents a graphical user interface (GUI) 120 that is presented to an Internet user on a web browser, e.g. Netscape Communicator and Microsoft Internet Explorer. Such GUI is generated by the ASP 108 and IIS 110 (FIG. 1) when the user logs on to the uniform resource locator (URL) address of the website operator. The GUI 120 includes a navigation window 122, a sample picture window 124, a ruler 126 for scale, and a comments field 128. The navigation window 122 permits the user to navigate through wire-mesh product samples that have finer mesh, coarser mesh, thicker wires, and thinner wires, e.g. by clicking on a set of hyperlink buttons 130-133, respectively. The materials used in the wire-mesh product pictured in window 124 can be selected by clicking on any of several buttons 134-142, e.g. Brass, Bronze, Copper, Galvanized, Micronic, Sintered, Welded Stainless Steel (SIS), Woven Stainless Steel, and Other. It may occur that meshes and wire sizes available in one material may not be available in another material. Amplifying remarks about the wire-mesh product currently selected are provided in the comments field 128.

The website design is such that the discrete products the user can view are those that the seller operating webserver 102 is offering for sale, or at least are those that the seller can actually produce and deliver.

The ruler 126 is a scale provided for the user to understand a picture 144 of a wire-mesh product being presented in window 124. Alternative views of the product, if available, can be accessed by clicking on a set of alternative view buttons 146-148. Such alternate views are presented instead of an initial sample product in picture 144. It the user is curious about the price of the product currently displayed in picture 144, a price button 150 is used to go to a webpage with current pricing. An order button 152 can be clicked-on to take the user to a product ordering webpage. A search button 154 and a help button 156 are provided for navigation help.

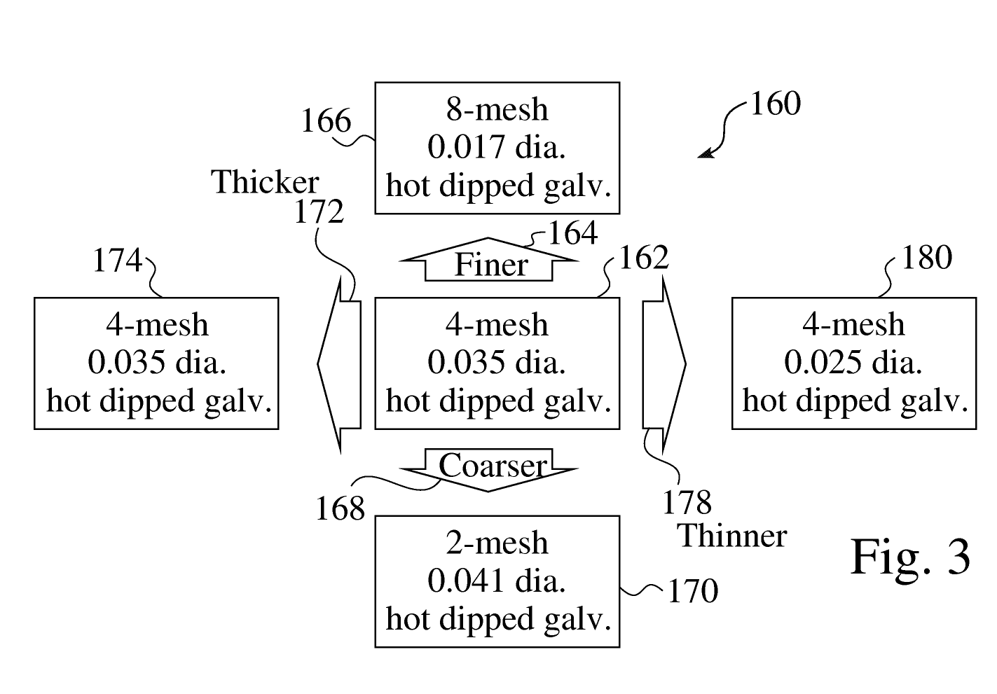

A dataflow 160 in FIG. 3 represents the effects of the finer-mesh, coarser-mesh, thicker-wires, and thinner-wires hyperlink buttons 130-133 (FIG. 2). For example, a starting position 162 is for a hot-dipped galvanized 4×4 mesh with 0.035″ diameter wire. A finer navigation-direction 164 takes the user to a hot-dipped galvanized 8-mesh with 0.017″ diameter wire in a position 166. Such represents the only choice for finer mesh from the starting position 162, a thinner wire is necessitated by requesting a finer (higher count) mesh. A coarser navigation-direction 168 takes the user to a hot-dipped galvanized 2-mesh with 0.041″ diameter wire in a position 170. Such represents the only choice for coarser mesh from the starting position 162. A thicker wire is not necessitated by requesting a coarser (lower count) mesh, but the thicker 0.041″ diameter wire represents the only product configuration the seller chooses to produce and sell. A thicker navigation-direction 172 points to a no-link position 174. Such occurs when there is no available product choice in that direction. A thinner navigation-direction 316 takes the user to a hot-dipped galvanized 4-mesh with 0.025″ diameter wire in a position 180. Such represents the next choice for thinner-wire mesh from the starting position 162. The mesh count remains at 4-mesh.

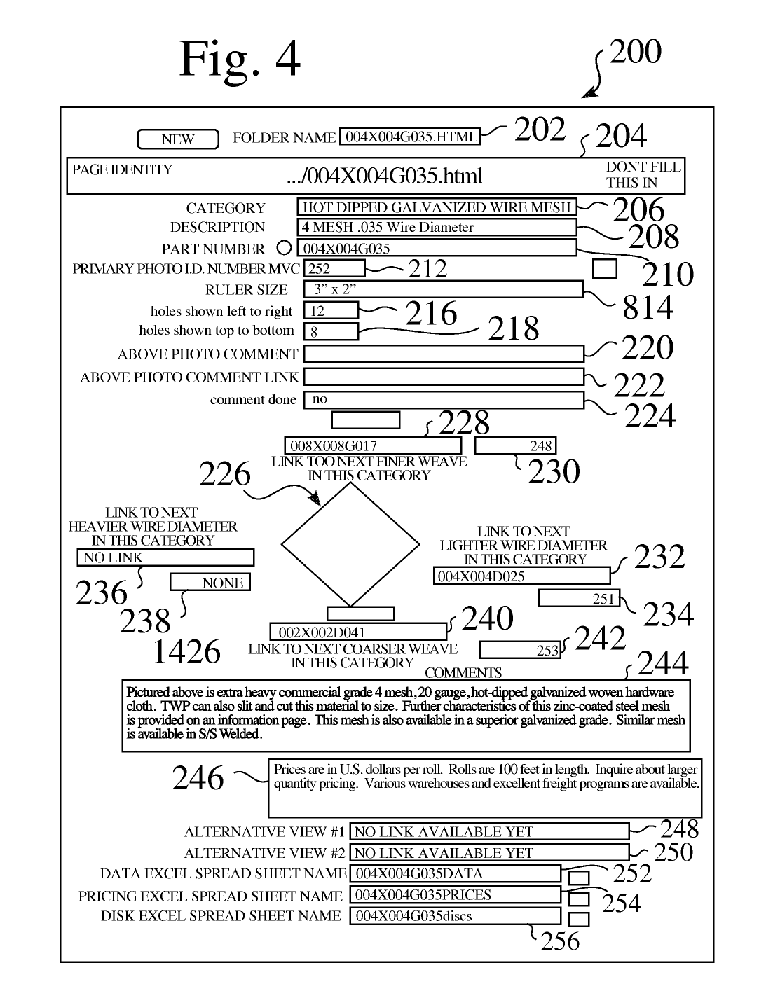

The dataflow 160 in FIG. 3 can be used by a web designer in implementing embodiments of the webserver 102 (FIG. 1). A more detained implementation would be assisted by creating webpage fill-in forms like those illustrated in FIGS. 4-7. A commercially marketed computer program sold by FileMaker, Inc., called FILEMAKER-PRO, provided good results for such forms.

FIG. 4 diagrams a form 200 that corresponds to the implementation of position 162 (FIG. 3). A folder name 202 is filled-in with “004X004G035.HTML”, e.g. the hypertext mark-up language (HTML) for 4×4 mesh galvanized 0.035″ diameter. A URL 204 designates where the HTML file will be found on the Internet, e.g. “http://www.TWNPINC.com/004X004G035.html”. This is read, using hypertext transfer protocol, within the World Wide Web, at TWPINC.com, file 004X004G035.html. In actuality, the domain name server (DNS) converts the “TWPINC.com” part to a four-place Internet protocol (IP) address in the form “00.00.00.00”. A category box 206 allows for a common grouping, e.g. “Hot Dipped Galvanized Wire Mesh”. A description box 208 is used to enter the common product name, e.g. “4-Mesh 0.035 Wire Diameter”. A part number box 210 provides information necessary to order this product, e.g. “004X004G035”. A photo-ID box 212 identifies which GIF or JPG picture file relates to this particular product, e.g. “252”. Such information is used to control what appears in product picture 144 (FIG. 2). A ruler-size box 214 is filled in with information that corresponds to the scale used in the picture file recited in the photo-ID box 212. For example, “3 by 2 inches”. A horizontal dimension box 216 is filled-in with the number of holes, left-to-right, represented in the product picture. A vertical dimension box 218 is filled-in with the number of holes, top-to-bottom, represented in the product picture. A photo-comment box 220 provides for comments about the product picture. A photo-comment link box 222 provides for a file or URL link to information about the product picture. A comments-done? box 224 allows work-in-progress to be marked.

A four-way navigation symbol 226 signals the four directions a user can navigate, and corresponds to navigation window 122, especially buttons 130-133 (FIG. 2). A next-finer weave box 228 indicates a product description, file, or URL to be taken, e.g. “008X008G017”. A next-link photo box 230 corresponds to the item in the next-finer weave box 228. A next-lighter-wire box 232 indicates a product description, file, or URL to be taken, e.g. “004X004G025”. A next-link photo box 234 corresponds to the item in the next-lighter-wire box 232. A next-heavier-wire box 236 indicates a product description, file, or URL to be taken, e.g. “no-link”. See, position 174 (FIG. 3). A next-link photo box 238 corresponds to the item in the next-heavier-wire box 236. A next-coarser weave box 240 indicates a product description, file, or URL to be taken, e.g. “002X002D041”. A next-link photo box 242 corresponds to the item in the next-coarser weave box 240. A comments box 244 includes remarks that the webpage designer wants to appear in the comments field (FIG. 2). Similarly, a price-table comments box 246 includes remarks that the webpage designer wants to appear when prices are quoted. An alternate view-1 box 248 is used for alternative product photos that will be displayed as picture 144 in response to clicking on button 146 (FIG. 2). An alternate view-2 box 250 is used for alternative product photos that will be displayed as picture 144 in response to clicking on button 148 (FIG. 2). An Excel spreadsheet name box 252 is used to link to a corresponding prices file, e.g. as would be invoked in response to clicking button 150 (FIG. 2). A disk Excel spreadsheet name box 256 is included.

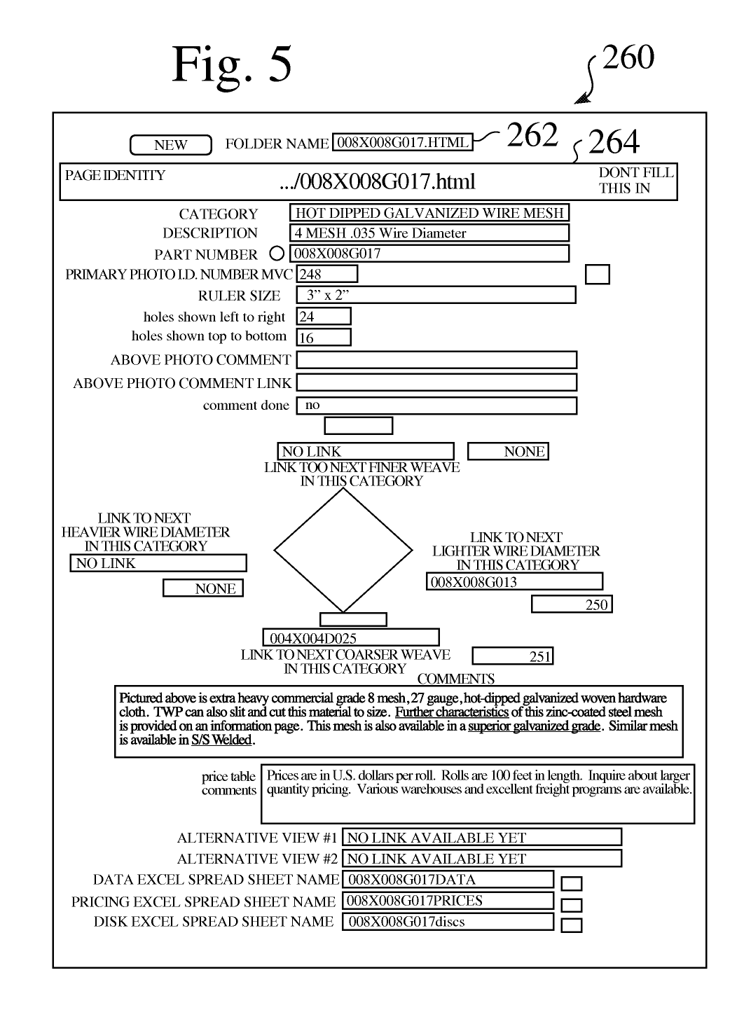

FIG. 5 diagrams a form 260 that corresponds to the implementation of position 166 (FIG. 3). A folder name 262 is filled-in with “008X008G017.HTML”, e.g. the hypertext mark-up language (HTML) file for 8×8 mesh galvanized 0.017″ diameter. An URL 264 designates where the HTML file will be found on the Internet, e.g. “. . . /008X008G017.html”. The rest of the form 260 is similar to that represented in FIG. 4.

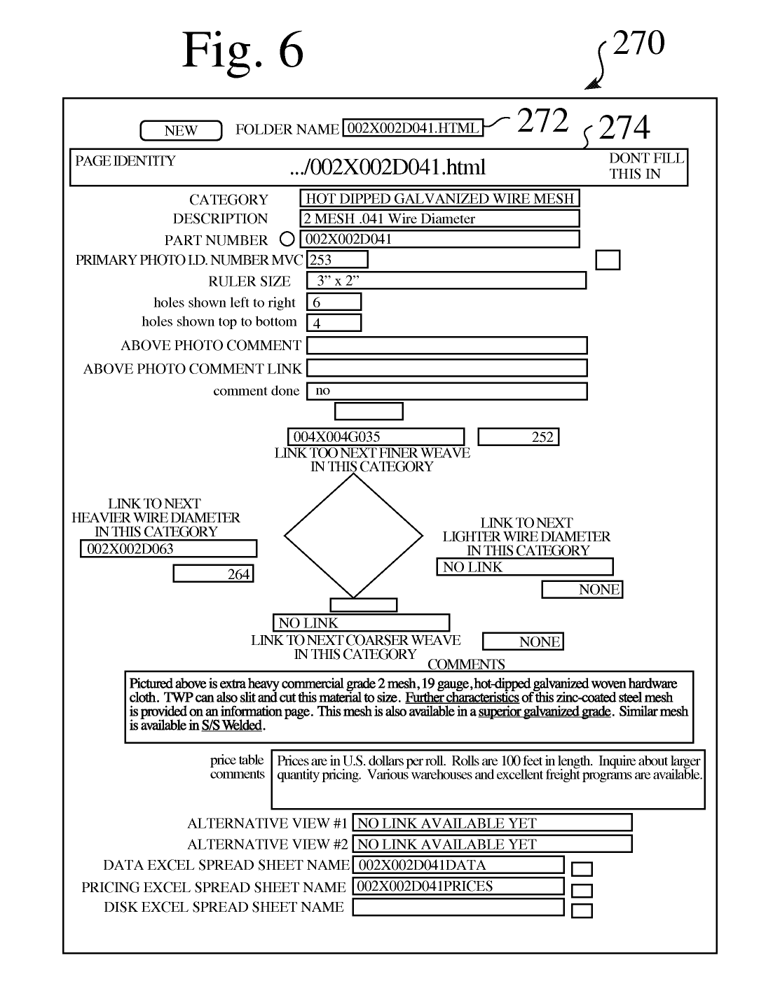

FIG. 6 diagrams a form 270 that corresponds to the implementation of position 170 (FIG. 3). A folder name 272 is filled-in with “002X002G041.HTML”, e.g. the hypertext mark-up language (HTML) file for 2×2 mesh galvanized 0.041″ diameter. An URL 274 designates where the HTML file will be found on the Internet, e.g. “. . . /002X002G041.html”. The rest of the form 270 is similar to that represented in FIG. 4.

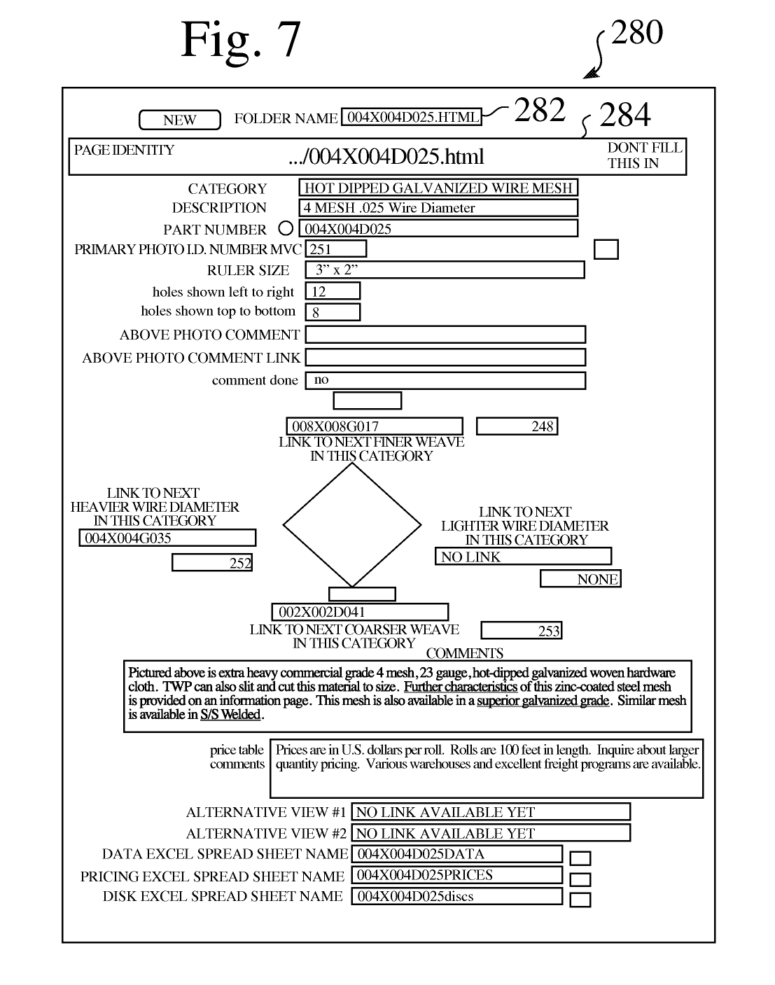

FIG. 7 diagrams a form 280 that corresponds to the implementation of position 180 (FIG. 3). A folder name 282 is filled-in with “004X004D025.HTML”, e.g. the hypertext mark-up language (HTML) file for 4×4 mesh galvanized 0.025″ diameter. An URL 284 designates where the HTML file will be found on the Internet, e.g. “. . . /004X004G025.html”. The rest of the form 280 is similar to that represented in FIG. 4.

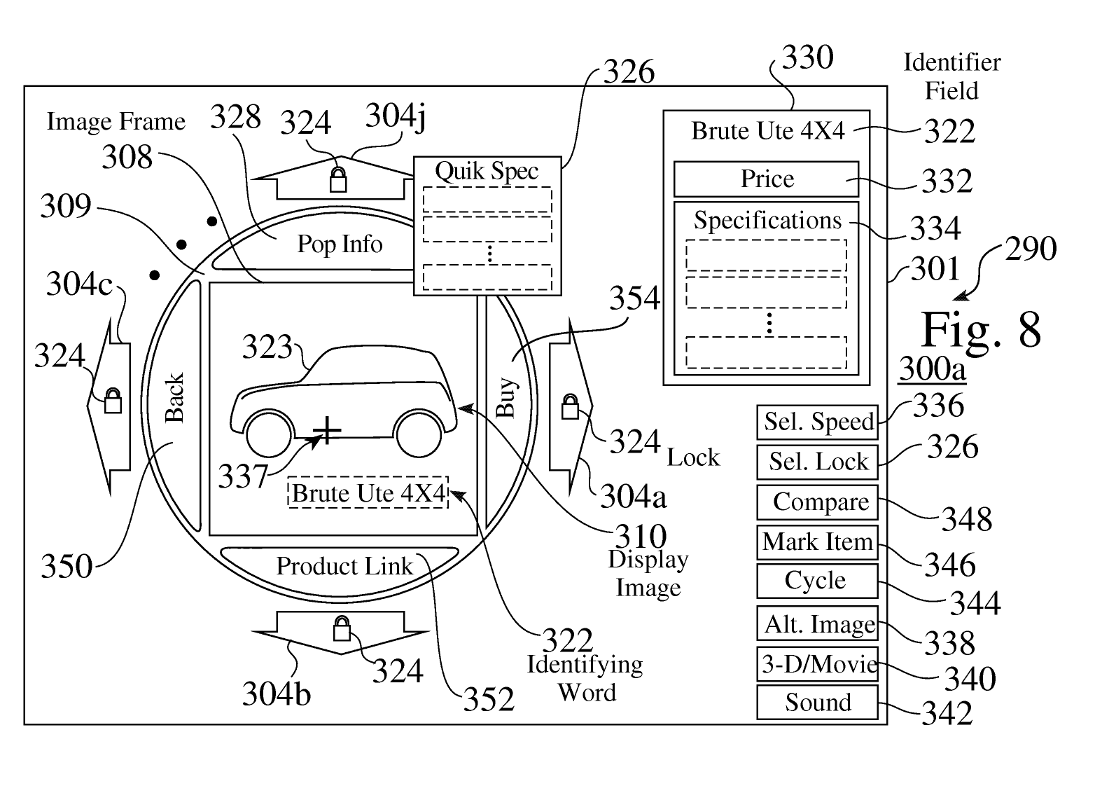

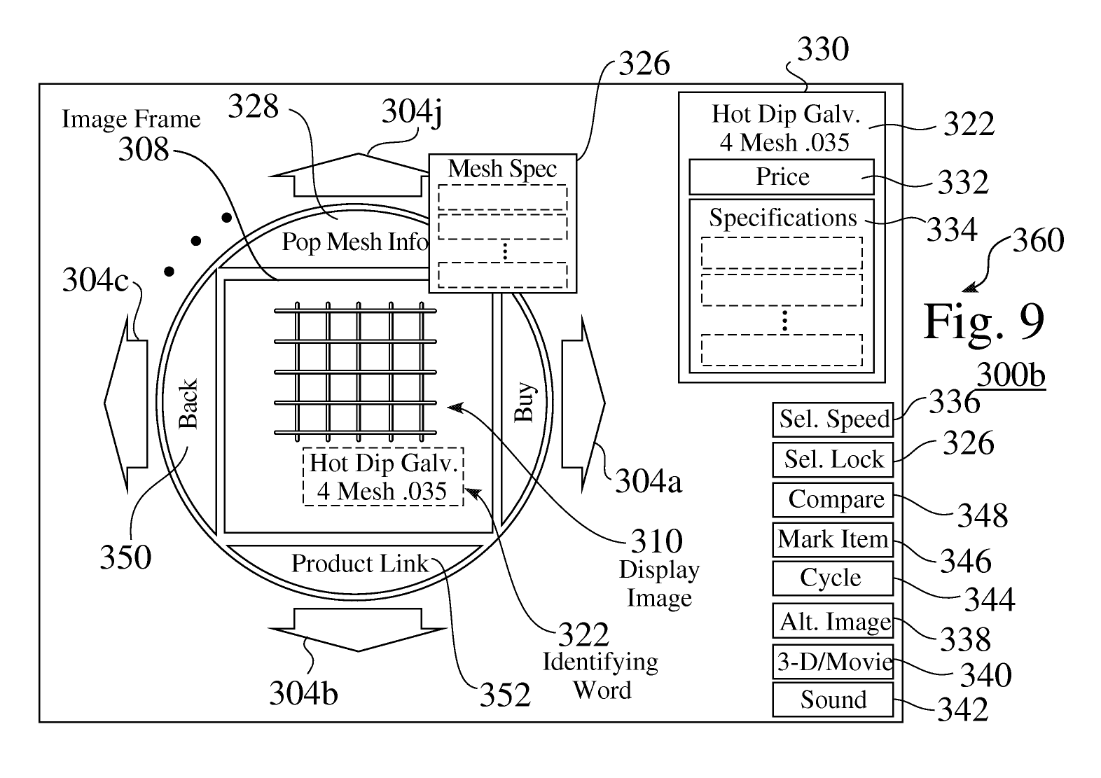

FIG. 8 is a detailed schematic view 290 of an enhanced button and display selection interface system 300, e.g. 300a. FIG. 9 is a detailed schematic view 360 of an alternate button and display selection interface system 300b, such as for exemplary selection for a wire mesh product. The selection interface systems 300a,300b may preferably comprise user interfaces that are implemented through a web browser, such as for selection, sales, and/or marketing across the Internet.

The exemplary button and display selection interface system 300a shown in FIG. 8 provides an interface, such as comprising one or more interface screens 301, by which a user can readily browse through vehicle products 323. While some embodiments 300a are used for merchandising the vehicles 323 of one manufacture, such as through a single terminal or computer 106 (FIG. 1), alternate system embodiments 300 are readily implemented to merchandise vehicles 323 from a variety of manufacturers, such as through a plurality of computers 106a-106k and a remote, i.e. host computer 102 (FIG. 1).

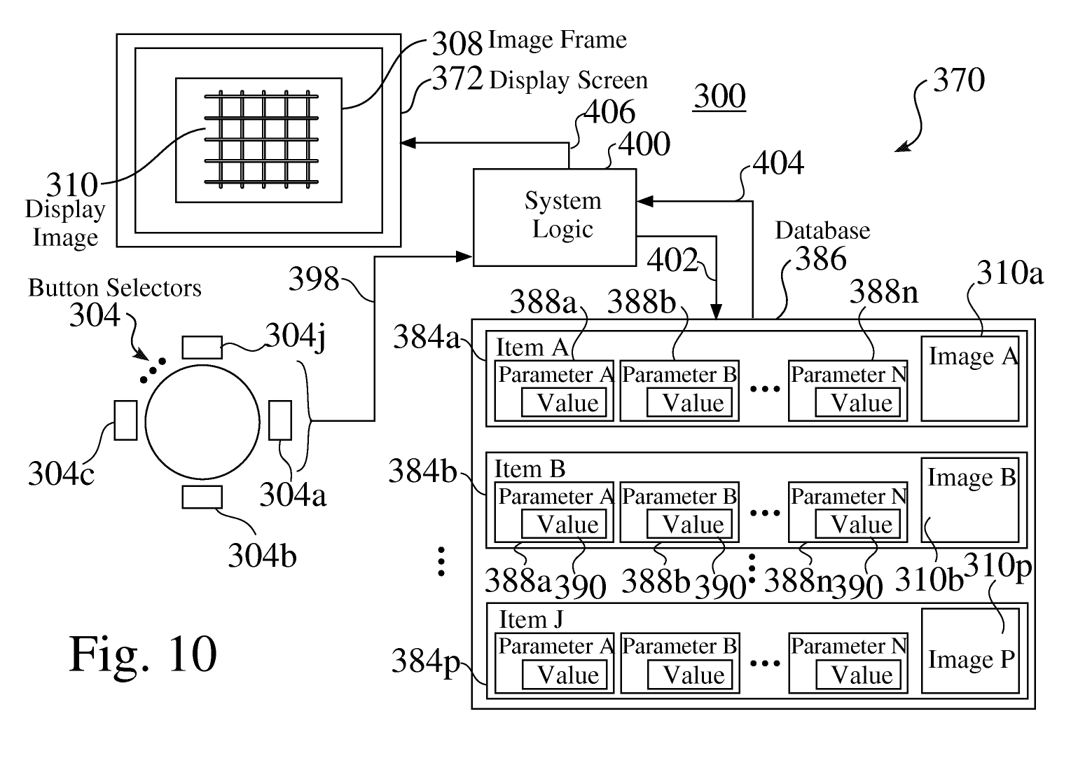

As seen in FIG. 8, the button and display selection interface system 300a comprises a plurality of feature buttons 304a-304j, which are controllably activatible with respect to the graphic user interface. The buttons 304a-304j are adjustable to select from various items 384 (FIG. 10), e.g. such as vehicles 323, which meet desired selection parameters 388 (FIG. 10), e.g. price, power, size and/or options. For example, a user may initially select vehicles 323 with a size parameter 388b, and may subsequently select from those vehicles 323 to find vehicles 323 which meet a price selection 388a. From the vehicles 323 that meet both size and price selections 388, the user may then adjust other selection buttons 304, such as a power button 304j, to select other desired characteristics, i.e. parameters 388.

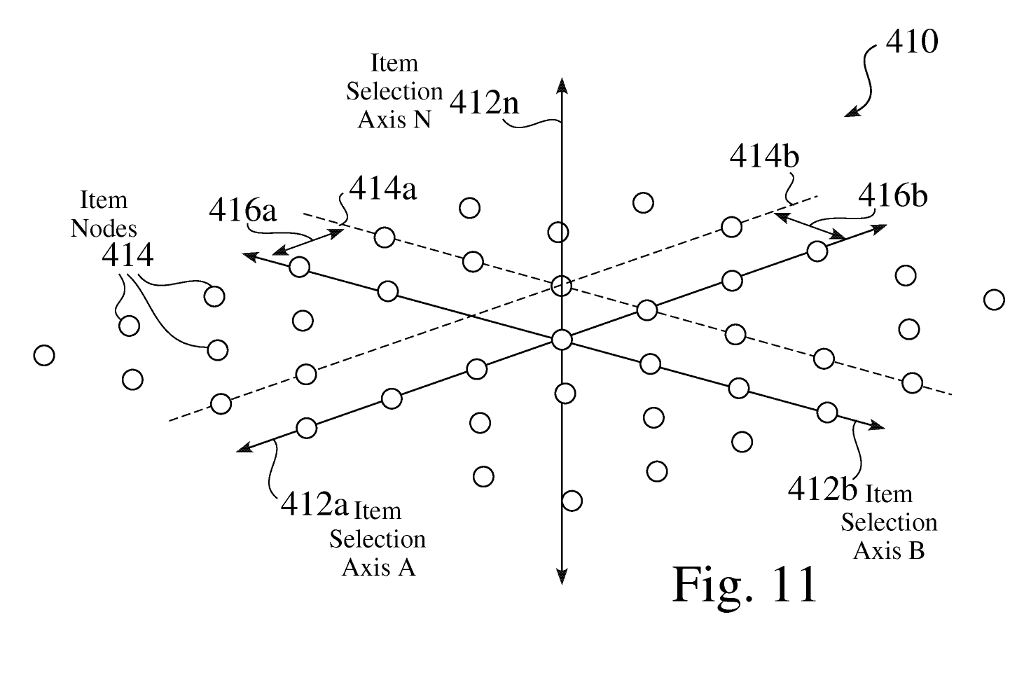

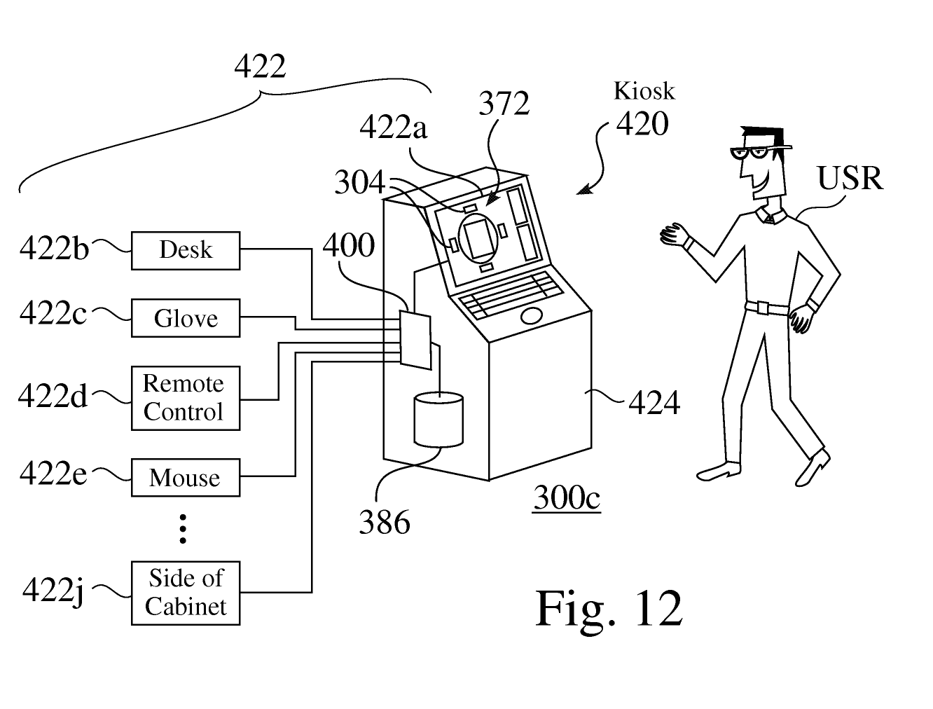

The button and display selection interface system 300a further comprises an image frame 308, such as within but not limited to an inner region 309 defined within one or more buttons 304a-304j. A display image 310 is typically retrieved and displayed, whereby a user USR (FIG. 12) can see a photograph or illustration of a currently selected item 384. Other information 322 related to the current selection 384 may also be shown, such as embedded within the image frame 308, either as part of the image 310, or composited over the image 310. The embedded information 322 typically comprises one or more embedded words, such as a product name, a product number or code, or other item specifier 322.

As well, other information regarding the selected item 384 may readily be seen and/or accessed, such as through a quick specification window 326 or other field 326 near the image 310, e.g. either to appear automatically, as a user moves a mouse cursor 337 over the image 310, or to appear through a pop info control 328. For example, in the button and display selection interface system 300b implemented for merchandising wire mesh products, an information button or glyph 328 is located near the image frame 308, such that activation reveals information about the a selected mesh product 384.

Additionally, an information screen 330 may be provided, whereby information is readily displayed for the user, such as to display a product name 322, pricing information, 332, or other specifications 334. In some system embodiments, the information screen 330 appears once a selected item 384 is set, i.e. frozen.

As seen in FIG. 8 and FIG. 9, the button and display selection interface systems 300a,300b preferably comprise a wide variety of selection enhancements. For example, selection locks 324 on one or more selection buttons 304 allow a user to “lock” a selected parameter 388, such as price 388a, whereby only items which strictly meet a locked parameter 388 are presented to the user, while an unlocked parameter 388 may allow the system to approximate a parameter 388, based on available products 384.

In some system embodiments 300, a parameter that is not locked 324 is typically free to show all items 384 that meet the other controlled parameters 304,388. For example, in a system 300 for viewing criminal suspects, an unselected hairstyle feature allows the system to approximate any hair parameter 388, based on suspects who meet the other selected parameters 304,388. In some system embodiments 300, even if a user selects one hairstyle feature, an unlocked hair parameter 388 may allow the system to approximate a hair parameter 388, based on suspects who meet the other selected parameters 388.

In some system embodiments 300, locks 324 preferably provide either a hard lock 324, e.g. to rigidly specify a selection, or a soft lock 324, e.g. to specify an approximate lock 324. For example, in a soft lock condition 324, if a user selects a “silver” value 390 for a color parameter 388 of a vehicle 323 in a vehicle selection system 300a, the system 300a may show stock of similar “platinum metallic” or “gray pearl” colors, which may readily meet the user's needs. In a similar soft lock condition 324 of vehicle selection system 300a, a user selection of a price parameter 388 may allow vehicles 323 that substantially meet a price selection 388, e.g. within a specified percentage or tolerance, to be displayed.

As seen in FIG. 8 and FIG. 9, the button and display selection interface systems 300a,300b may further comprise a selection speed control 336, to adjust the speed at which items are retrieved and displayed. A selection lock 326 allows a user to lock in a selected item 384, such as to freeze a selection 384 and corresponding image 310 for longer examination.

In some system embodiments 300, the images 310 light up, or highlight a purchase or shopping cart button 354 (FIG. 8), whereby a user may check stock, order, and/or purchase a selection 384. As well, a navigation button or product link 352 (FIG. 8) may be provided and preferably highlighted, whereby the user may navigate to other information, either within a product section of the host site, or to a linked site. A back button 350 may also be provided, such as to toggle to previous parameter selections 388 and/or selected items 384.

The button and display selection interface systems 300a,300b seen in FIG. 8 and FIG. 9 also comprise mark item control 346, compare item control 348, and cycle items control 344, whereby a user can mark, compare, and/or toggle between selections 384. For example, in a motor vehicle selection site 300a, a user may want to compare features between three compact cars 323, either having the same or similar features 388, or having different selected features 388, e.g. the user may opt for a higher performance engine in one car 323, or a premium interior in another car 323, and then compare features.

Some embodiments of the button and display selection interface systems 300 also preferably comprise enhanced display and sound features, such as through alternate images 338, 3-D visualization or movie access 340, and/or through sound control 342. For example, through alternate images 338, a plurality of images 310 for a selected item 384 may be presented to a user, such as front, side, rear, and perspective views of a vehicle 323. Similarly, alternate images 310 of different items 384 which each meet the selection criteria may be cycled.

As well, before selection of parameters 388, the pictures 310 of a product section of a website may cycle through a series of images that relate only to products 384 in that section, e.g. such as a sequential display of different product lines for a manufacturer. For example, upon approaching a kiosk 420 (FIG. 12), a user may be presented with a series of sequential images 310 of available items 384. In a selection system 300, e.g. 300a for selection of vehicles 323, a sequence of product families may be presented, e.g. such as sub-compacts, intermediates, luxury, sports, pickup trucks, station wagons, and/or SUVs.

Some embodiments of the button and display selection interface systems 300 may also comprise access to three-dimensional display, animation, or movie clip 340, such as to provide a walk-around view of a product 384, to provide a walk-through of a building, or to access multimedia information regarding one or more product features. As well, sound access 342 preferably provides sound information, such as narrative information, music, or other sound data 342.

While the exemplary button 304 seen in FIG. 8 and FIG. 9 resemble arrows and are located around the circumference of the image frame 308, selection buttons 304 may comprise any desired shape, and may be located or arranged at any location with respect to an interface 300. In some interface embodiments, the buttons may be located within an image 310, and may appear as buttons or as part of the image itself, e.g. wherein touching a wheel of a vehicle 323 allows the user to intuitively toggle through different wheel choices.

System Operation. FIG. 10 is a functional block diagram 370 of a selection interface system 300, which comprises storage, navigation, and display of items 384 that match selected criteria. The database 386 shown in FIG. 10, such as representing one or more databases 116 shown schematically in FIG. 1, is populated with selectable information corresponding to a plurality of items 384a-384p. Each item component 384 comprises one or more feature parameters 388a-388n, within which is assigned a corresponding value 390, and typically comprises one or more corresponding images 310a-310p. While the exemplary database 386 shown in FIG. 10 is shown as a single database entity 386, the stored information can reside at one or more locations.

As seen in FIG. 10, a button selection interface 300 may comprise one or more buttons 304a-304j, by which a user can readily navigate, select, view, compare and/or purchase items 384. As a user controls a button selector 304, a selection signal 398 is sent to the system logic module 400, e.g. a processor 400. The database 386 is queried 402, to determine one or more items 384 that correspond to the combined selections 304a-304j. The results 404, which correspond to one or more matching items 384, comprise product information and images 310, which are returned 404 and displayed 406, either through the processor 400, or directly to the display screen 372. An image 310, such as image 310a, is thereby displayed within the image frame 308.

While some system embodiments 300 comprise HTML pages that are pulled in response to a selection, the selection interface system 300 is readily integrated into other environments. Some current system structures pull, i.e. call, information from the database 116, 386 such as through a job description in My SQL and PHP, wherein images are retrieved from an SQL database 116,386 and are displayed in response to JAVA commands.

While the selection interface 304 shown in FIG. 10 is shown independently from the display screen 372, other embodiments of the user selection interface system 300 comprise an integral graphic user interface system 300, such as seen in FIG. 8 and FIG. 9.

Item Selection Axes and Nodes. FIG. 11 is a perspective schematic view 410 of selectable nodes 414 on a plurality of selection axes 412a-412n. Within the user selection system 300, a user may quickly navigate and select one or more items 384 from a large plurality, i.e. a universe, of items 384, as represented by nodes 414 in FIG. 11. Selection buttons 304 provide control on one or more selection axes 412, such as between product values 390 for feature parameters 388 (FIG. 10). The nodes 414 are separated 416, e.g. 416a or 416b, such that a user is typically limited to select between node values 414, i.e. available feature values 390.

For example, in a wire mesh merchandising system 300b (FIG. 9), mesh values per inch are typically limited to either currently available meshes, or, upon special order, manufacturable meshes. Therefore, mesh values that are not manufacturable, or are not currently available, do not appear as a valid node 414. Through subsequent selection and control of selection buttons 304, a user may quickly navigate to a mesh product that meets the needs of an end user and is also available or manufacturable.

FIG. 12 is a schematic view of a kiosk 420 comprising a selection interface system 300c, which can either be networked 104, or can function as an independent selection kiosk 420, with an internal processor 400 and database 386, e.g. such as for a store, a shopping center, a convention or a vending machine. In alternate kiosk embodiments 420, stored item, product, entity, or commodity information is updated periodically, such as to serve a point of service kiosk, e.g. for a store, a shopping center, a library, or a convention.

As also seen in FIG. 12, the buttons 304 associated with the selection interface 300 may comprise one ore more input mechanisms 304, such as but not limited to buttons 304 associated with any of a monitor or touch screen 422a, a desk 422b, a glove 422c, a remote control 422d, a mouse, trackball or track pad 422e, or one or more buttons 304 located on a surface of a cabinet 424, e.g. a side 422j of the cabinet 424.

Sample System Applications. The selection interface system 300 can be used for a wide variety of applications, and is ideally suited for environments in which a user desires to make a selection from a large plurality of items and properties, such as but not limited to parts, components, assemblies, consumer goods, transportation, electronics, materials, or services. A user may readily select and gain access to an image 310 or other information, e.g. 322,332,334, related to a generic, i.e. available item/class of items 384 having multiple properties, by which a most nearly matching item is selected from a universe of such items 384.

The selection interface system 300 allows a user to quickly navigate to a selection of one or more items 384, which most closely meet the desired parameters 388, without wasting time with items 384 that do not meet the desired parameters, while avoiding a specification of an item, such as a product, part, material, or commodity, which is not “available” or possible, i.e. not currently manufactured, not in stock, and/or is not a feasible selection.

Furthermore, the selection interface system 300 may preferably provide a composite selection interface, such as for profiling, animation, architecture, or modeling, wherein portions of an image 310 are retrieved and displayed, in response to user selections 390.

As well, the selection interface system 300 may readily be enhanced by front-end or back-end systems. For example, an introductory screen on a vehicle merchandising system can determine the class of vehicle to be selected. Similarly, a back-end enhancement in a vehicle selection system may provide a product link, a shopping cart function, or a list of local suppliers.

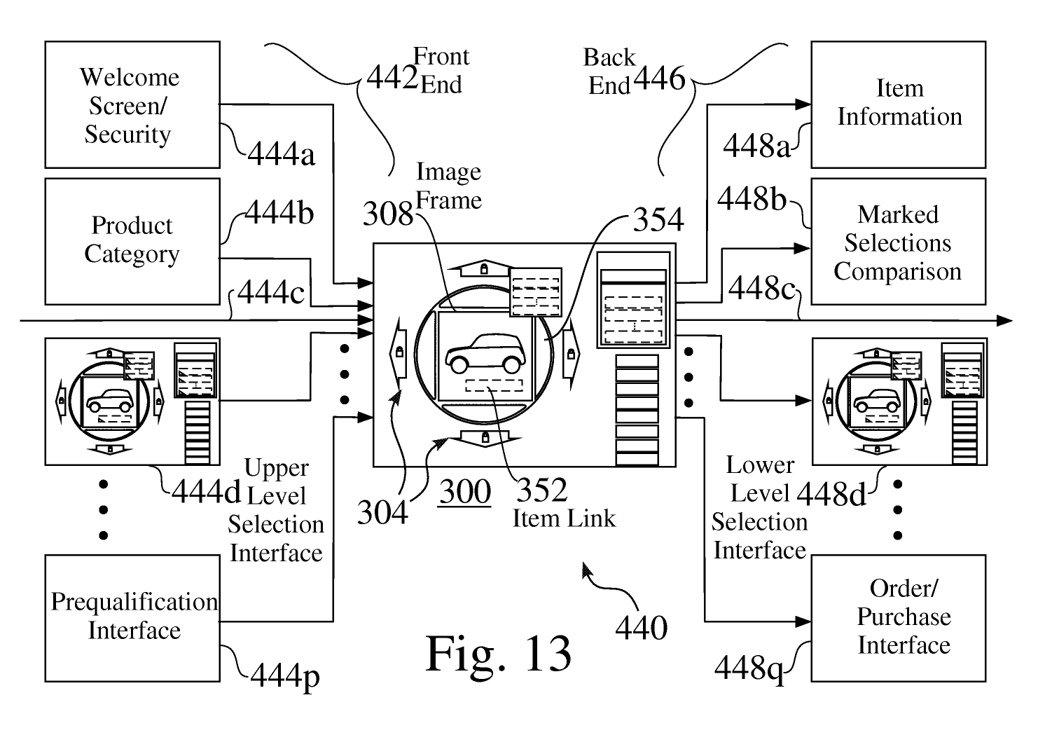

FIG. 13 is a schematic view 440 that shows an exemplary front end 442 and back end 446 to a selective interface system 300 having buttons 304. As seen in FIG. 13, the selective interface system 300 is readily accessed at a client terminal or computer 106, e.g. 106a (FIG. 1), either directly 444c, or through a wide variety of linked pages 444a-444p. For example, the central selective interface system 300 shown in FIG. 13 is accessible through a welcome/security log-in screen 444a, a product category selection screen 444b, a direct link 444c, an upper level selection interface 444d, or a pre-qualification interface 444p.

Similarly, the selective interface system 300 may preferably comprise a selectable back end 446, either directly 448c, or to a wide variety of linked pages 448a-448q. For example, the central selective interface system 300 shown in FIG. 13 provides access to an item information screen 448a, e.g. as linked through a product link icon or button 352 (FIG. 8), a marked selections comparison screen 448b, a direct external link 448c, a lower level selection interface 448d, e.g. to select more features 388, or an order/purchase interface 448q, e.g. as linked through a buy icon or button 354 (FIG. 8).

In a back-end enhancement in an exemplary criminal suspect selection system 300, a retrieved image may additionally be rendered to modify features, such as to provide age progression, or to change other facial characteristics, e.g. such as the addition of a beard, moustache, glasses, and/or scar. In a back-end enhancement in an exemplary cosmetic or reconstructive surgery selection system 300, a retrieved image may additionally be rendered to modify features, such as to provide age reduction, or to display other modifiable facial characteristics, e.g. such as for nose reshaping, wrinkle removal, and/or scar reduction.

The selection interface system 300 is readily adaptable for other selection systems, such as within a graphic user selection interface for education or entertainment items. For example, within a media delivery channel or movie selection interface, a user can easily navigate to desired programming, e.g. within selectable movie button choices for movie type, movie year, and available stars, a user can readily navigate to search for western movies starring Gary Cooper within a given year.

While some embodiments of buttons 304 may provide basic navigation between selectable nodes 414 that correspond to items 384, other embodiments of buttons 304, such as for a selective interface system 300, may provide a wide range of functionality.

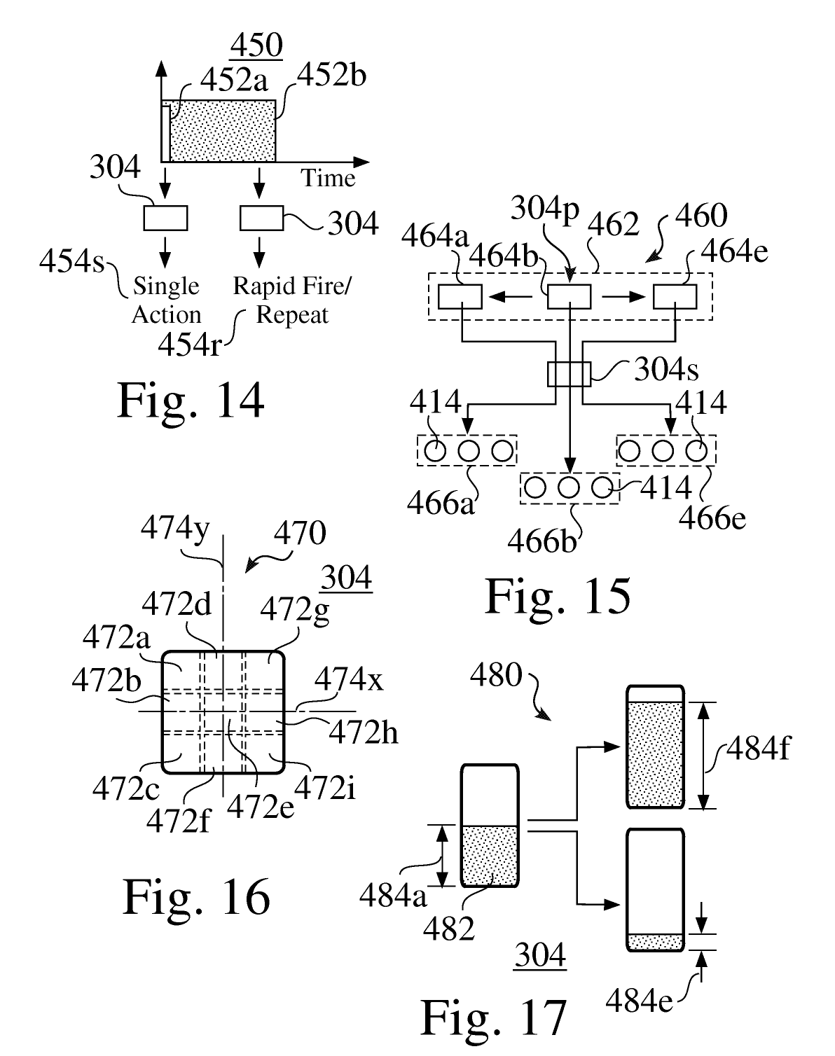

FIG. 14 is a schematic depiction 450 of exemplary buttons 304 that provide time-dependent interaction 454. For example, a first button 304 is activated by a user USR for a short duration 452, e.g. 452a, which results in a single action 454, e.g. 454s, such as to navigate from one node 414 (FIG. 11) to a neighboring node 414. A second button 304 is activated by a user USR for a long duration 452, e.g. 452b, which results in a rapid fire or repeated action 454, e.g. 454r, such as to quickly navigate from one node 414 to a node 414 that is greater than one node away. Similarly, some buttons 304 may provide pressure sensitivity, to provide controlled speed between a plurality of nodes 414.

FIG. 15 is a schematic view 460 of an exemplary button 304, e.g. 304p that is controllably selectable 462 to determine what a secondary button 304, e.g. 304s selects. For example, as seen in FIG. 15, a first primary button 304p is controllable between a set 462 of button positions 464a-464e. When the primary button 304p is in a first position 464a, the secondary button 304s is controllably selectable to choose between a first set 466a of nodes 414. When the primary button 304p is in a second position 464b, the secondary button 304s is controllably selectable to choose between a second set 466b of nodes 414. Similarly, when the primary button 304p is in an alternate position 464e, the secondary button 304s is controllably selectable to choose between an alternate set 466e of nodes 414.

FIG. 16 is a schematic view 470 of an exemplary button 304 that may be singularly used within a button selection interface 300, such as to provide navigation between a universe of selectable nodes 414. The exemplary button 304 seen in FIG. 16 may also be controllably tilted to advance in more than one direction. For example, the button 304 seen in FIG. 16 comprises a plurality of regions 472, e.g. 472a-472i.

As seen in FIG. 16, the button regions 472a, 472b and 472c are located generally to the left of a vertical axis 474y, while button regions 472d, 472e and 472f are located generally along the vertical axis 474y, and the button regions 472g, 472h and 472i are located generally to the right of the vertical axis 474y. As also seen in FIG. 16, the button regions 472a, 472d and 472g are located generally above a horizontal axis 474x, while button regions 472b, 472e and 472h are located generally along the horizontal axis 474x, and the button regions 472c, 472f and 472i are located generally below the horizontal axis 474x.

The button seen in FIG. 16 may be tiltably operated by a user USR, based upon the actual or virtual tilt applied, such as based upon which region 472 is pushed. A user USR may therefore tilt the button 304 to the right to advance through selectable nodes 414, and/or may tilt the button to the left to retardably move through the selectable nodes 414.

In some embodiments, the user USR may tilt the button 304 upwardly to advance through selectable nodes 414, and/or may tilt the button downwardly to retardably move through the selectable nodes 414. The button 304 seen in FIG. 16 may furthermore be tilted with respect to both axes 474, e.g. through sectors 472a,472c,472g, and/or 472i, such as to move between a plane of selectable nodes 414, e.g. simultaneous control of more than one parameter. The button 304 seen in FIG. 16 may also comprise pressure sensitivity, such as to provide further control, such as along an axis 474 of nodes 414 away from or into a plane defined by 474x and 474y.

FIG. 17 is a schematic view 480 of an exemplary button 304 that may preferably provide a display 482 that is related to a value, wherein the display 482 appears to fill or empty as the related value changes. The display 482 may be directly associated with a position selected by a user USR, e.g. a selected speed value of 5 on a scale of 1 to 10, a sixth item 384f in a group of ten items 384, or may be associated with an external value, e.g. such as but not limited to an available inventory. As seen in FIG. 17, the height 484a of the displayed value 482 indicates a generally central value, whereas a height 484f of the displayed value 482 indicates a generally full value 482, while a height 484e of the displayed value 482 indicates a generally emptied value 482. In an exemplary selective interface 300 used for process control, the button display 482 may reflect a relative fluid level in a vessel, while the button 304 may provide selectable control for a pump or valve to reach a desired level node 414, such as to transfer fluid into or out of the vessel. In another example, the display 482 may reflect how may times the user has clicked on that button 304, e.g. a user USR may be limited to clicking a button 304 a limited number of times.

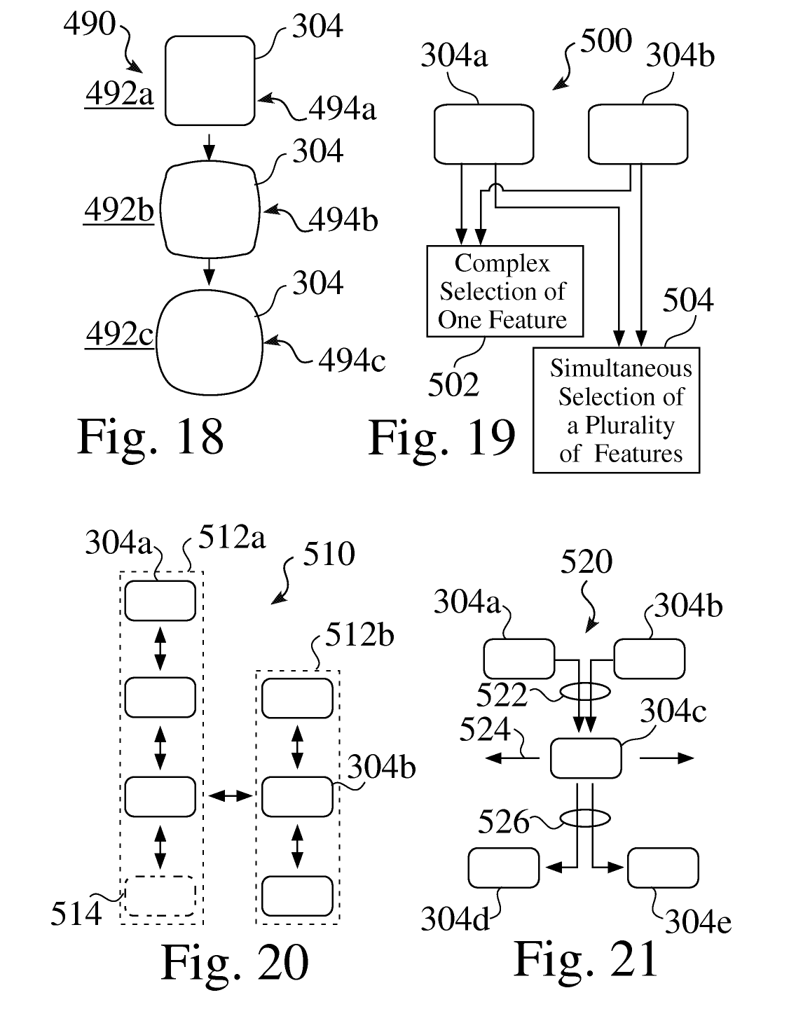

FIG. 18 is a schematic view 490 of an exemplary button 304 that provides a displayed contour 494 that changes as a function of activation or applied pressure upon the button 304 by the user USR, such as within a user interface 300 having pressure sensitive input. As seen in FIG. 18, an untouched button 304, i.e. having an applied pressure 492a of zero, has a first displayed contour 494a. The button 304 under initial contact or applied pressure 492b shows slight deformation, e.g. a squished-put contour 494b, while the button 304 under increased applied pressure 492c shows a significantly deformed or squished-out contour 494c. A button 304 that provides a displayed contour 494 that changes as a function of contact or applied pressure may be integrated with other button functions, such as for rapid fire or repeated operation 454r of a button 304 (FIG. 14), or for a button that provides a visual feedback 494 for tilt 472 (FIG. 16).

FIG. 19 is a schematic view 500 that shows the combined use of two or more buttons 304, e.g. 304a,304b, such as for complex selection 502 of one feature 388, or for simultaneous selection 504 of a plurality of features 388.

FIG. 20 is a schematic view 500, such as for a button and display interface 300, which shows an exemplary button 304a that grays out or disappears 514 at the end of choices 512a, and a second exemplary button 304b that appears if a set 512b of one or more selectable choices become available. For example, a button and display interface 300 for vehicle selection may provide a secondary button 304b that appears based on selectable interior options for a particular chosen vehicle model or body type, e.g. a button 304b that is associated a roof rack option and rack attachment accessories may only be visible and selectable for a hardtop vehicle.

FIG. 21 is a schematic view 520 of exemplary buttons 304 that may be rearranged 524, joined 522, and/or split 526, e.g. such as based upon the design of the interface 300, or based upon the user USR. For example, a first button 304a and its corresponding functionality may readily be combined 522 with that of a second button 304b, wherein a single button 304, e.g. 304c, may preferably provide controllable selection for feature parameters 388 previously controlled by buttons 304a and 304b. A button 304, such as button 304c seen in FIG. 21, may readily be rearranged 524, such as within an interface screen 301 (FIG. 8) or between interface screens 301. As also seen in FIG. 21, a button 304, e.g. 304c, and corresponding functionality may be split 526, such as to split different selection controls between two or more buttons 304, e.g. 304d and 304e.

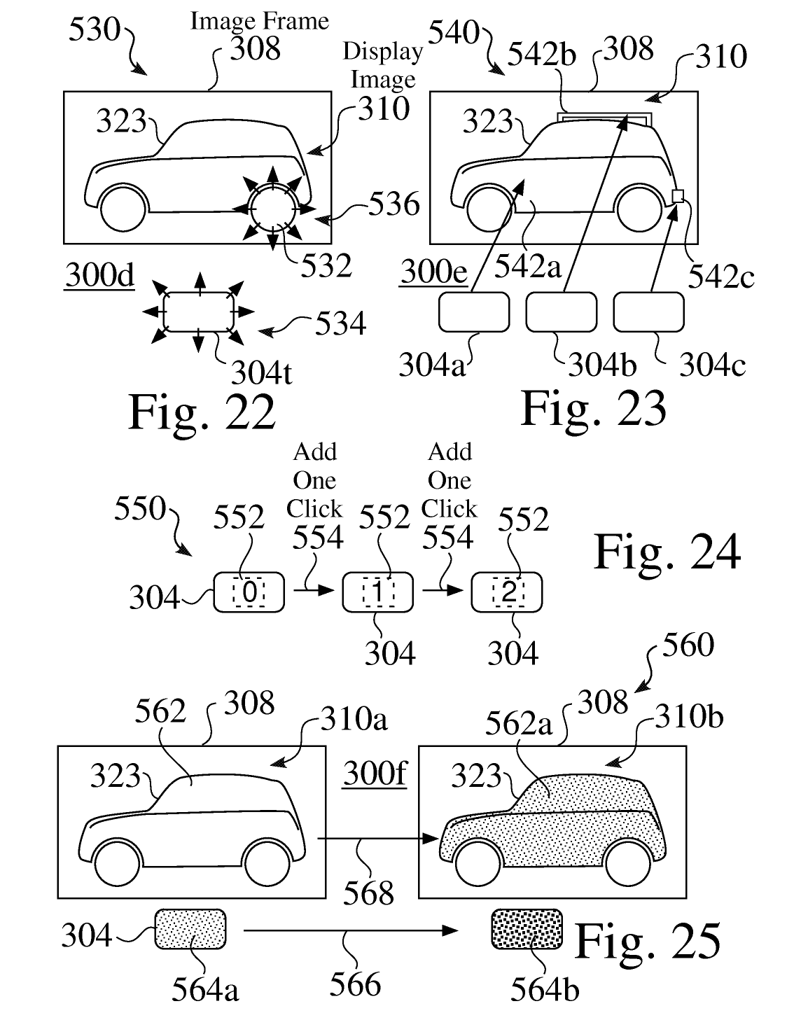

FIG. 22 is a schematic view 530 of a button 304, e.g. 304t, such as for an enhanced selective interface 300, e.g. 300d, that has a characteristic movement 534, e.g. throbbing or vibration, wherein a related feature 532, i.e. a connected characteristic, has a related characteristic movement 536, such as to indicate a connection or selection relationship between the button 304 and the feature 532. For example, as seen in FIG. 22, a button 304t for selection of tires for a vehicle 323 may indicate a characteristic movement 534, at the same time the tires 532 in a displayed image 310 show a characteristic feature movement 536. In an exemplary interface 300d, the related characteristic movements 534,536 may prompt a user USR to input values 390 for one or more selectable parameters 388.

FIG. 23 is a schematic view 540 of one or more button 304, e.g. 304a-304c, such as used within an enhanced button selection interface 300, e.g. 300e, wherein each button 304 may be selectively activated to add to or edit at least a portion of an image 310. In the exemplary embodiment 540 seen in FIG. 23, activation of a first button 304a may add an element or color to the image of the body 542a of a displayed vehicle 323, a second button 304b may add pixels associated with a roof rack 542b to the image 310 of the displayed vehicle 323, and/or a third button 304c may add pixels associated with a tow hitch 542c to the image 310 of the displayed vehicle 323. The elements 542 may be comprised of one or more pixels, such as to completely cover or replace pixels directly beneath them on the image 310, or may provide other effects, such as translucence or anti-aliasing, over the image 310.

FIG. 24 is a schematic view 550 of a button 304 such as used within a button selection interface 300, having a displayed number 552, e.g. 552, on or near the button 304, wherein the displayed number 552 indicates the number of times that the button 304 has been clicked 554. For example, as seen in FIG. 24, the button 304 initially has a displayed number 552a of “0”, which indicates that the button has not previously been clicked 554 by a user USR. After the user USR clicks 554 on the button, the displayed number 552 changes to “1”, and after the user USR clicks 554 on the button 304 again, the displayed number 552 changes to “2”. Similarly, such as for a button 304 that provides movement in more than one direction, as seen in FIG. 16, a button 304 may provide an indication of relative position, such as how many clicks 554 to the left or right of a central position, e.g. “−3”, “−2”, “−1”, “0”, “1”, “2”, or “3”.

FIG. 25 is a schematic view 560 of a button 304 such as used within a button selection interface 300, e.g. 300f, which has an appearance 564, e.g. 564a, which corresponds to a selectable or selected characteristic. The exemplary button 304 shown in FIG. 25 shows a selectable color characteristic 564 for a vehicle 323 in an image 310. For example, a first image 310a shows a vehicle 323 having a white body color 562, while a neighboring button 304 displays a first alternate selectable color 564a. If the user USR activates or clicks 566 the button 304, the vehicle body color is changed to the first alternate color 562a that corresponds to the first alternate selectable color 564a, while the button 304 then displays a second alternate selectable color 564b. Similarly, the same button 304 or a different button 304 may be used to reflect the current selected characteristic.

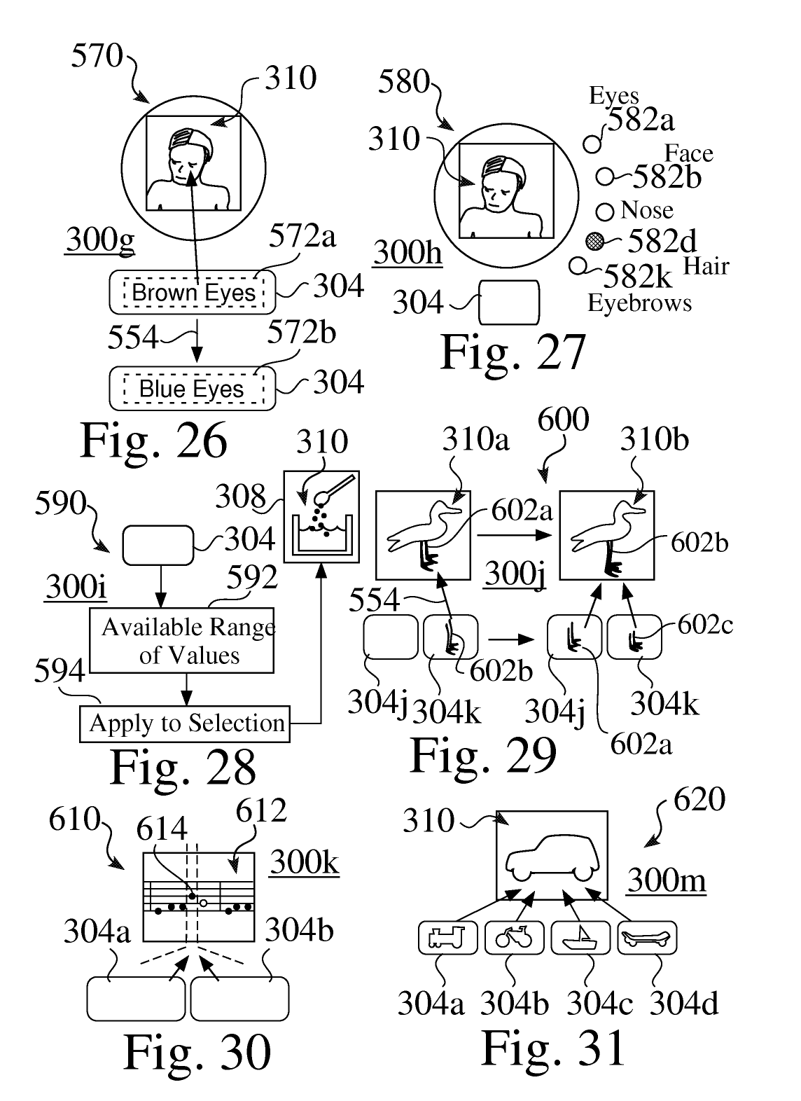

FIG. 26 is a schematic view 570 of an enhanced button selection interface 300g comprising a button 304 that has a displayable text label 572, e.g. 572a, which corresponds to a chosen feature 388. For example, an exemplary composite image 310 is seen in FIG. 26, wherein a button 304 that corresponds to eye characteristic parameters 388 first displays a text label 572a of “Brown Eyes”, e.g. overlaid upon the button or displayed near the button 304. The text label 572 typically comprises a text data field that corresponds to an image element or value 390. As also seen in FIG. 26, when a user USR clicks 554 on the button 304, the button 304 then displays a text label 572b of “Blue Eyes”, while the image 310 is updated with a corresponding image element 390. The user USR may sequentially press the button 304 seen in FIG. 26 to progress through a series of selectable values 390, wherein the text labels 572, if available for each choice 390, may preferably be displayed on or near the button 304.

FIG. 27 is a schematic view 580 of a button selection and display interface 300h, comprising a feature designation button 304 and a plurality of feature toggles 582a-582k, wherein the features toggles 582a-582k designate the current function of the button 304. The exemplary user selection interface 300h shown in FIG. 27 is implemented for composite human images 310, such as for facial composites. In use, one or more of the toggles 582a-582k within the selection interface 300h are typically activated, whereby a feature button 304 becomes active to control a feature parameter 388 that corresponds to an active toggle 582. For example, in FIG. 27, the hair toggle 582d is currently active, such that clicking the button 304 changes hair features 388 of the composite image 310. Similarly, activation of the face shape toggle 582b allows the button 304 to control a face shape feature 388 of the image 310. In alternate embodiments of the button selection and display interface 300, a toggle 582 can preferably cycle through a plurality of active features 388. As well, a feature sensitive button text label, numerical label, or icon 552 (FIG. 24) may preferably appear on or near the feature button 304, to indicate a currently active, i.e. selected, feature 388.

In a system embodiment 300h which provides a composite image 310, based upon user selections 304, selected feature values 390 are retrieved from a database 116, 386 and are composited to produce an image 310, such as by layering feature values 390, such as by opaque or translucent, i.e. sprite, layering. In an alternate embodiment 300, features of known people, e.g. such as known criminals, are quantized and/or categorized and stored, such that as a user navigates through facial or body features, images of one or more people which match the feature set may be presented 310 within the display window 308. Other details may similarly be overlaid on the image 310, such as clothing, hats, glasses, or accessories.

FIG. 28 is a schematic view 590 of an enhanced button selection interface 300i comprising a button 304 in which an available range 592 of selections is applied 594. For example, for an enhanced button interface 300 that is integrated with a process for mixing a composition, e.g. a recipe, a user USR may selectably click on a button 304 that corresponds to the selection of a measured quantity, e.g. volume measurement values of 1 cup, 2 cups or 1 quart, wherein selection of one of the values within a selectable range 592 may controllable be chosen and added to a composition, and may be indicated within a display window 308, such as by showing the addition of the selected measured quantity in an image 310.

FIG. 29 is a schematic view 600 of an enhanced button selection interface 300j comprising a plurality of buttons 304, e.g. 304j and 304k, wherein a user may intuitively toggle between a plurality of choices. In an exemplary first image 310a seen In FIG. 29, a bird image 310a includes a first leg type 602a, while the button 304k provides a display, e.g. on or near the button 304k, of a second leg type 602b. If the user USR clicks the button 304k, a second image 310b is displayed, in which the bird image 310b includes the second leg type 602b, while a secondary button 304j now displays the last chosen leg type 602a, and while the primary button 304k may display a third leg type 602c. In this manner, a user USR may readily navigate by clicking 554 through available choices. The user USR may then proceed to narrow down possible choices, such as by eliminating some of the choices through secondary control, wherein the user may choose between a smaller found set of possible choices 602, e.g. to identify a bird seen at the seashore earlier that day.

FIG. 30 is a schematic view 610 of an enhanced button selection interface 300k comprising one or more buttons 304 for sound control and/or editing, such as to control the duration, pitch or voice of one or more musical notes 614 within an arrangement or song 612.

FIG. 31 is a schematic view 620 of an enhanced button selection interface 300m comprising one or more buttons 304, e.g. 304a-304d, wherein the button choices are displayed outside the display area 310. As seen in FIG. 31, a display area 310 currently displays a car, such as to illustrate a chosen mode of transportation for a portion of a travel itinerary. As also seen in FIG. 31, a button 304a has a corresponding silhouette of a train, a button 304b has a corresponding silhouette of a bicycle, a button 304c has a corresponding silhouette of a boat, and a button 304d has a corresponding silhouette of a skateboard. The enhanced button selection interface 300m may be used for selecting between alternate choices, and/or may be used to provide hierarchical navigation through a plurality of choices, e.g. items 384, to find a desired item 384. For example, once a first set of buttons 304a-304d is used to define a primary group of items 384, e.g. bicycles, one or buttons 304 may then be used to navigate and choose a desired bicycle from a group of available bicycles.

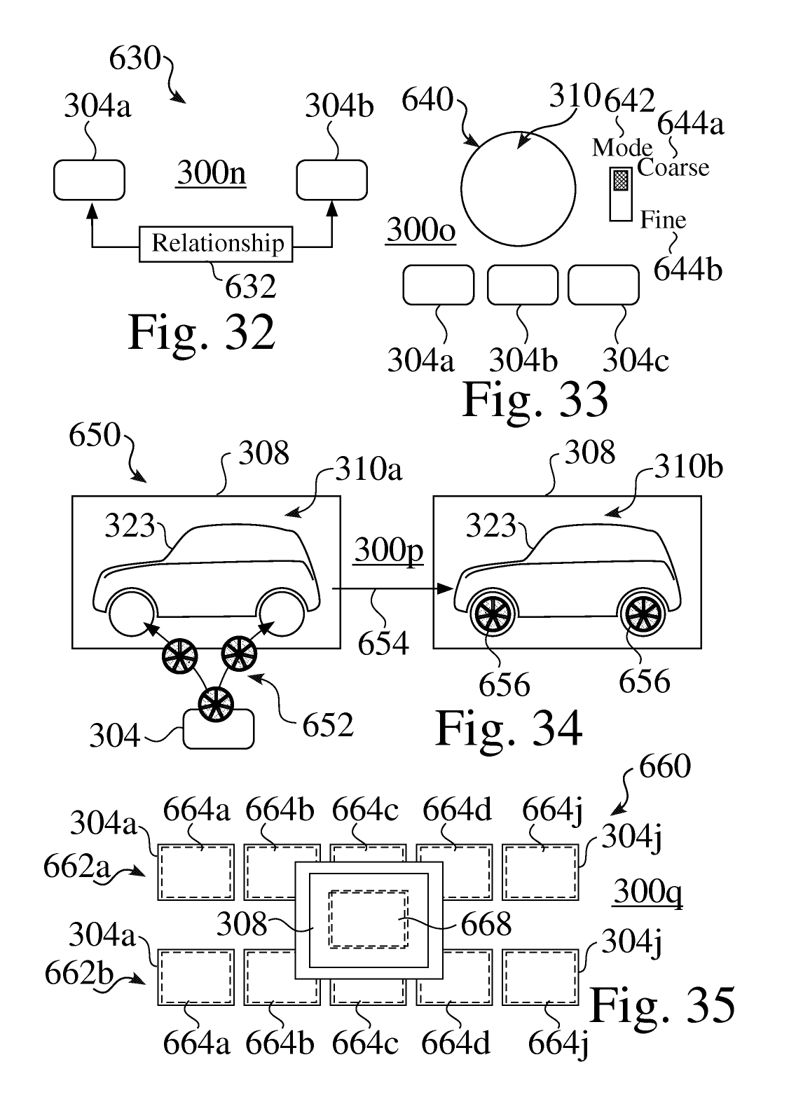

FIG. 32 shows a schematic view 630 of a button selection interface system 300n, wherein at least two of the button selectors 304, e.g. 304a and 304b, are joined together by a relationship 632, e.g. any of a simple or a complex relationship. The relationship 632 may preferably link or gear features together. For example, a simple relationship link or gear 632 for a shoe design interface 300 may lock a button selector 304, e.g. 304b, associated with shoe lace color to another button selector 304, e.g. 304a, associated with shoe sole color, so the that feature selectors 304, e.g. 304a and 304b, move in unison. Such selectors 304 may preferably be locked together for any of matching colors, or having different or related colors. As an example of a more complex relationship link or gear 632, the moisture needs of one selected plant may preferably be compared to the moisture needs of an adjacent plant in a selection interface 300 for landscape or garden design wherein one feature selection button 304, e.g. 304b, does not allow a non compliant plant to be chosen in an area having a plant having different needs that has been selected by another feature selection button 304, e.g. 304a.

FIG. 33 shows a schematic view 640 of a selection interface system 300o, wherein one or more feature selector buttons 304, e.g. 304a-304c, may preferably provide fine tuning, such as such as to provide filter choices for an image 310, e.g. such as but not limited to red, redder, lighter, saturate, unsaturated, and/or anti-aliasing. For example, in a first selection mode 644a, a user USR may select broad color categories, e.g. blue, red, green, yellow, etc. on a feature selector button 304, e.g. 304a, and in a second mode 644b, such as activated with a mode control 642, the user USR may select between different shades of a color selected in the first mode, e.g. different shades of blue. Similarly, a user USR may apply other effects to an image 310 through one or more of the buttons 304.

FIG. 34 shows a schematic view 650 of a selection interface system 300p, wherein one or more feature selector buttons 304 may preferably initiate an animated addition 652 of chosen attributes to a display area 308. For example, as seen in FIG. 34, when a user USR activates a button 304 that corresponds to a wheel choice 656 for a vehicle 323, an animated image 652 of the chosen wheels 656 appears to slide from the button 304 to the screen 308, wherein the image 310a of the vehicle 323 is updated 654, resulting in an image 310b that incorporates and/or reflects the chosen wheels 656.

FIG. 35 shows a schematic view 660 of an exemplary selection interface system 300q, having one or more sequences 662, e.g. 662a,662b, e.g. rows, of buttons 304, e.g. 304a-304j, having corresponding images 664a-664j, wherein the rows 662 lie, e.g. horizontally, across the interface 300q, while an exemplary display screen 308 is located within the interface 300q, such as near or on top of the rows 662. As one or more of the buttons 304 are touched, the touched button 304 moves, e.g. to the left or right, and displays the image 664 that corresponds to the button 304 that the user USR touched. For an interface 300q having a plurality of button sequences 662, e.g. 662a,662b, a composite image 668 of one or more images 664 that correspond to selected buttons 304 for the sequences 662, e.g. 662a,662b, may be displayed, or the user may determine which of the chosen images is displayed at any given time, e.g. such as for editing, display and/or broadcast of synchronized video feeds 662.

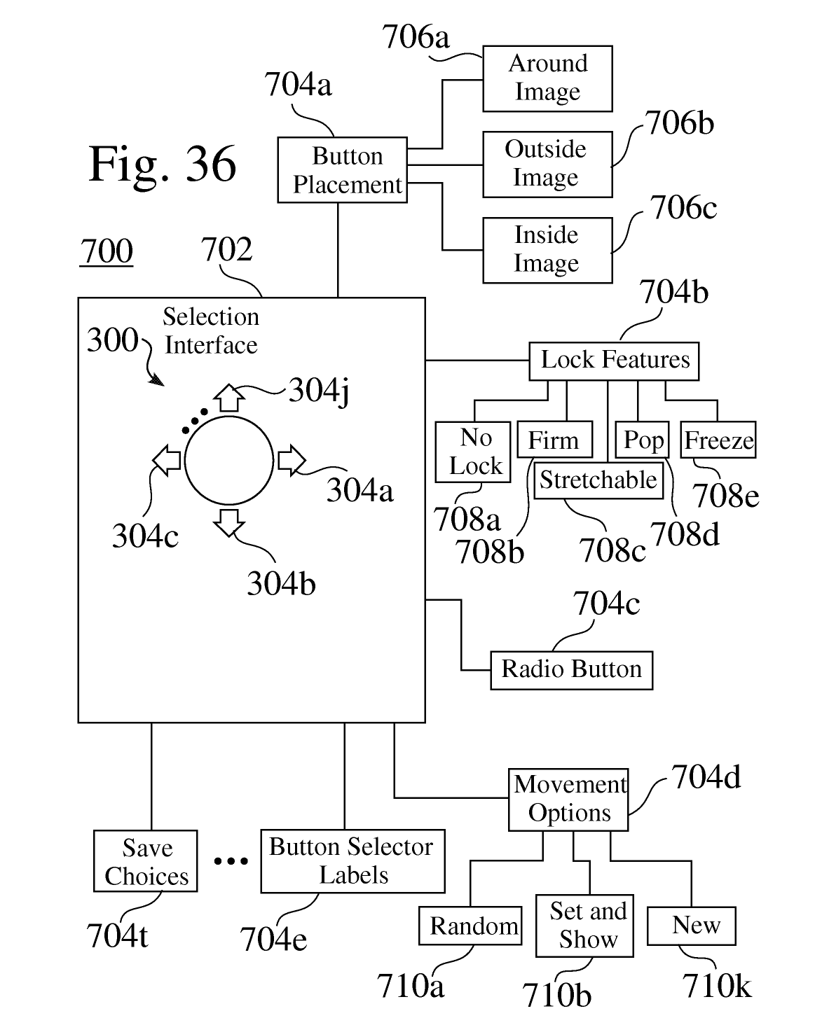

FIG. 36 shows a process 700 for designation 704, e.g. 704a-704t, i.e. assignment and/or control, of features for a button selection interface system 300, such as implemented though a computer or network interface 702 having one or more processors configured therewith.

As seen in FIG. 36, an administrative user, interface designer, or other user USR may designate 704a the location of one or more feature selectors 304, e.g. selector buttons 304, in relation to an image 310, such as around 706a an image 310, outside, i.e. alongside 706b an image 310, or inside 706c an image 310.

As also seen in FIG. 36, lock features may preferably be designated 704b, such as through a computer or network interface 702. For example, one or more selector buttons 304 may be designated 708a without associated locks 324. As well, one or more selector buttons 304 may be designated 708b with firm associated locks 324, e.g. such that no changes may be made in regard to a choice that has a firm lock 324.

Similarly, one or more selector buttons 304 may be designated 708c with flexible or stretchy associated locks 324, e.g. wherein a change may be made in regard to a choice that has a stretchy lock 324, if a user is insistent. Such a lock 324 may indicate, e.g. such as through any of image or sound, a straining to be released when the lock 324 does not allow a selection. On one such embodiment, a stretchable lock 324 may preferably pull sideways or wiggle to be set free if a specific combination of choices is not available.

For example, in a selection interface system 300 associated with vehicle selection, if a user limits possible vehicles to a mileage rating of 30-35 miles per gallon, such as by locking 324 a feature selector 304 associated with mileage, the user USR may not be able to activate one or more feature buttons 304 to indicate a sport utility vehicle model having a V8 engine. In this example, a lock 324 set on a mileage rating of 30-35 miles per gallon may flex or otherwise show straining as the user attempts to choose a particular vehicle model. Such a straining stretch lock 324 may preferably pop 708d either temporarily, while the characteristic that is causing it to strain is being held, or it could pop 708d permanently into the next position, e.g. to a mileage selection of 25-29 miles per gallon. When a stretchy lock 324 “pops”, such as from a prior position to a new position, the new position becomes the position of the previously locked button 304, wherein all the other parameters that were included or excluded change to be synchronized with previously selected buttons 304.

In contrast to a lock structure 324, one or more feature selector buttons 304 may preferably be selected 708e to “freeze up”, even without a lock 324, such as if changing a given feature selector 304 would only result in an impossible choice, wherein another button 304 may preferably be required to be clicked first. For example, in a selection interface system 300 for selecting a vehicle, a feature selector 304 associated with a vehicle model may be required to be changed or selected before allowing activation of a secondary feature selector 304, e.g. 304c, associated with interior options.

The selection of lock features 704b may also comprise how locking is initiated by a user USR, e.g. turning a button or holding a button down for a time that exceeds a time threshold, or indicated by the interface, e.g. turning color change or an image or label located on or near a locked or unlocked button 304.

As also shown in FIG. 36, button selectors 304 may preferably be designated 704c to comprise a means for selecting a position, e.g. a radio button 304, such as by a determination of an intended discrete selection based upon approximate movement or position, e.g. in relation to indicia, such as but not limited to a line, a pointer or an arrowhead.

As also seen in FIG. 36, feature buttons 304 may preferably be designated 704d with means for navigating between possible choices. For example, one or more button selectors 304 may be designated 704d to move randomly, such as to allow a user USR to view different combinations with a sequence of images 310 in the image window 308. During such a sequence, the user interface 300 may further comprise means for stopping the sequence, or for scanning forward or backward through a series of images 310.

A user USR may also select one or more of such presented images 310, and/or may lock one or more of the selection buttons 304, wherein random movement 710a may progress through any remaining, i.e. unlocked, button selectors 304. For example, for a user USR who attempts to identify a red bird that they saw near the seashore, the user USR may preferably lock 324 a color feature selector 304 on “red”, and similarly set a lock 324 for a “terrain” feature selector 304 on “Seashore”. The user USR may then move 704d one or more remaining feature selectors 304 by activating the remaining buttons 304, e.g. such as but not limited to a discrete button 304 to show remaining options or possibilities 710b, wherein all the red sea birds appear sequentially in the image window 310. As well, one or more of the available reasonable choices may be saved in new buttons 304 for comparison and further manipulation. For example, the images 310 of red sea birds that are found in the above example could spawn a new button 304 for each of the possible species, e.g. such as for but not limited to further refinement.

As also seen in FIG. 36, one or more button feature selectors 304 may preferably be labeled or otherwise marked 704e, such as to indicate where to move such a button selector 304 to achieve a desired characteristic, such as by but not limited to text, colors, shapes or icons arranged on the button selector 304. A currently selected characteristic may preferably bloat, illuminate, or otherwise highlight, to show what is currently selected with a button selector 304. For example, in an embodiment for selecting various options for a motorcycle, as the user USR clicks a button selector 304 past motorcycle engine selections, when a “six cylinder” selection passes by an arrow or other indicia that indicates a selection, a typeface for “6 CYL” on the button selector 304 may preferably turn to bold.

As shown in FIG. 36, a resultant image 310 on within an image window 308, as well as the settings of one or more button selectors 304 that result in the image or selected item, may be saved 704t. For example, a user USR may design a pair of sneakers within a selective interface system 300, such as by selecting styles, colors, soles, and/or laces. At any point in the design process, the user USR may preferably save a resultant design, e.g. such as by dragging the image and/or the feature settings to a holding dock within a page interface 301.

FIG. 37 shows an exemplary embodiment of a selective interface system 300r, having a plurality of sets of button selectors 304, wherein each set of button selectors has an associated image window 308, e.g. 308a-308c. The selective interface system 300r seen in FIG. 37 may therefore allow a plurality of images 310, e.g. 310a-310c, to appear within the interface 300r. While the plurality of sets of button selectors 304 may allow independent operation, some embodiments may provide interrelated operation, such as wherein the images 310 and/or items associated with the images 310 may comprise a set that may have at least one common feature, e.g. between a plurality of images 310 or associated items.

In one example of such a selective interface system 300r, a dinnerware set may commonly comprise a feature in common 724, e.g. a handle design, while separate items within a set may also have distinctive features, e.g. such as but not limited to knives, forks, spoons. Another example of such a selective interface system 300r may allow the creation of a design for interrelated cartoon superheroes, wherein each of the superheroes each has separate facial and/or body characteristics, but with at least one common wardrobe feature, e.g. such as but not limited to a uniform, shoes, or accessory, wherein such a common feature may be driven by a common button feature selector 304, e.g. a shoe color selector. As well, while a preliminary design for a first item or image 310 may be implemented using a first set of button selectors 304, one or more selections may be cloned or saved to neighboring feature selectors 304, e.g. such as to establish common features for a set of items, and then to modify distinctive features for different items.

The selective interface system 300, such as the selective interface system 300r seen in FIG. 37, may also comprise a feature in combination 726, such as but not limited to an additive interaction, between a plurality of selectable items and associated images 310, such as but not limited to a combined weight, cost, or duration. For example, if the total weight of a group of superheroes is not allowed to exceed a weight set point, and the individual button 304 created superheroes weight adds up to over the weight set point, the buttons 304 may preferably not allow the parameter to be exceeded. In similar system embodiment 300r, if the cumulative weight is exceeded, the cumulative power, speed or endurance for the group may decrease.

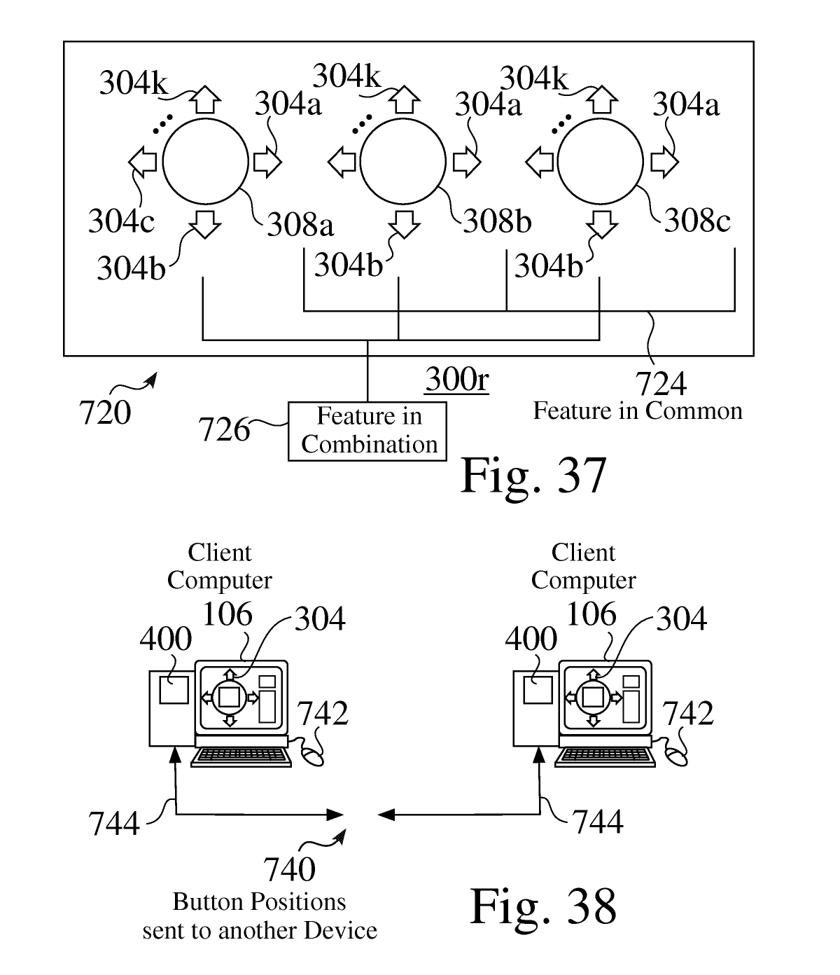

FIG. 38 is s schematic diagram that shows how information from a selective interface system can be sent to another device, such as to another selective interface system. The positions of one or more feature selectors 304 may be captured, such as but not limited to an electronic signal or a mechanical link. For example, a selected position of a first button selector 304 may a fifth selection of a group of positions, while the selected position of a second feature selector is at a second position of the group of positions. This information may thus preferably be sent 744 or mechanically geared to a connected but remote button selector 304 that can reproduce the image from the positions of the feature selector buttons 304.

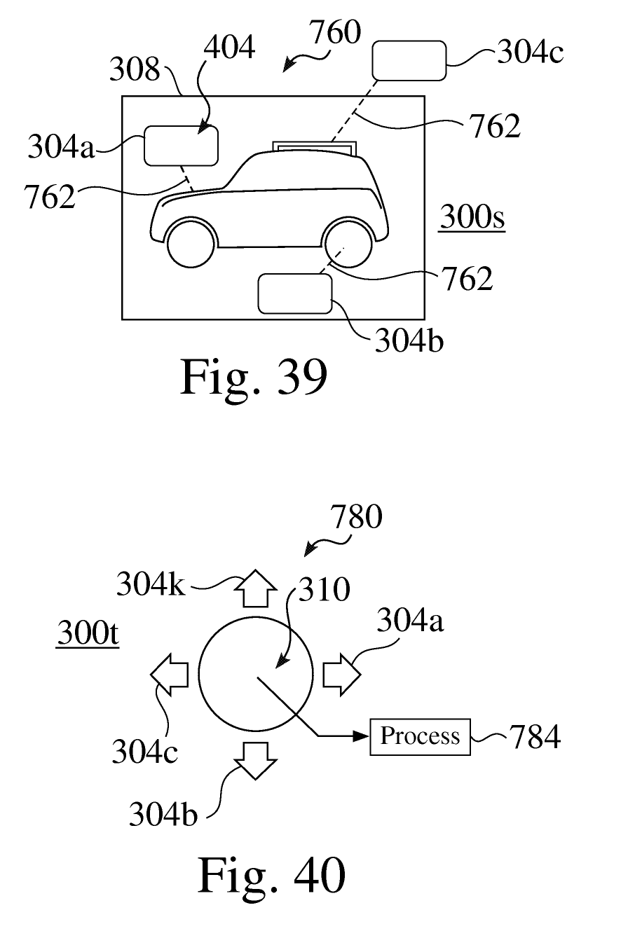

FIG. 39 is a schematic view of a selective button interface system 300s, wherein an image 310 further comprises touch sensitivity. For example, in one such embodiment 300s, if a user USR touches one part of an image 310, e.g. the hood, wheels, or roof of a vehicle 323, one or more button selectors 304, such as surrounding the image 310 or within the image 310, become active to select associated features, e.g. engine choices. Such user actions may also initiate other content associated with the highlighted button selector 304, such as but not limited to associated text, sound, and/or animation. As seen in FIG. 39, lines 762, e.g. dotted lines, may preferably appear to lead between a button and a selectable characteristic. For example, a first button 304a is connected 762 to the hood region of a vehicle 323, wherein the first button 304a provides selectivity for an engine. Similarly, a second button 304b provides selection of wheels and/or tires, and a third button provides selection of a roof rack.

FIG. 40 is a schematic view 780 of a selection interface system 300t, wherein an image or video output 310 associated with the buttons 304 may preferably be further connected to a process or task 784, e.g. to control or produce the part or assembly in the real world, e.g. the selected object 310 does not have to be virtual. For example, the selective interface system 300t may preferably run a machine tool, e.g. a lathe, wherein the button selectors 304 provide means for selection of a diameter, length, thread pitch, and/or thread start and length, wherein the selections may preferably exclude unrealizable thread/diameter combinations. Such controls may preferably provide selectable characteristics, such as but not limited to removing or adding material, changing the color, and/or changing the porosity of a real object. In some embodiments, the selection interface system 300t may preferably interface to a printer (2D or 3D), an automatic cocktail mixer or a gene/chromosome assembler.

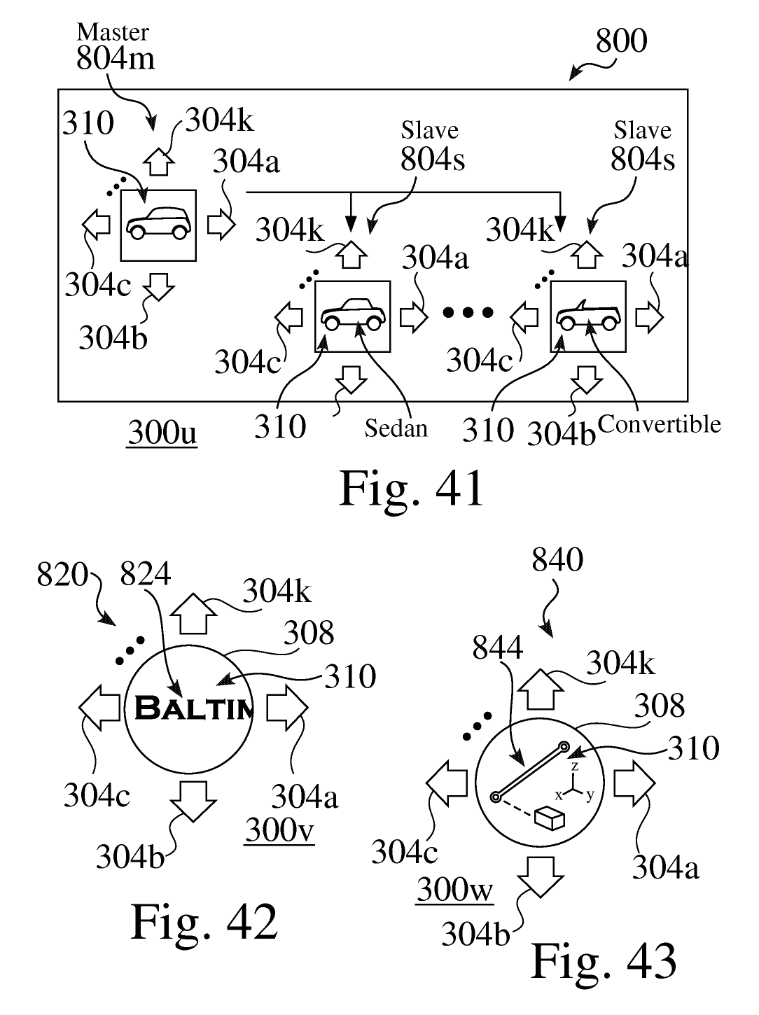

FIG. 41 is a schematic view 800 of an alternate embodiment of a selection interface system 300u, wherein multiple selection interfaces 804 may preferably be synchronized, such that different versions of a resultant image 310 are saved. For example, an exemplary synchronizable selectable interface 300u may be opened that comprises a plurality of vehicle selector interfaces 804, e.g. comprising a master interface 804m and one or more slave interfaces 804s. As a user USR clicks a button 304 on the master interface 804m, all the images 310 corresponding to the slaves 804s move through colors selected through the master 804m. For example, when the user USR chooses and locks red on a master exterior color selection button 304, both the master 804m and the slaves 804s display red vehicle images 310. Similarly, the user USR may click the master tire color selector button 304, e.g. 304c, wherein all the vehicle images 310 show cars with black tires.

While features that are consistent throughout all the choices are typically selectable through the master interface 804m, features that are meant to be specific may preferably be selectable through one or more of the slave interfaces 804s. For example, in one of the slave interfaces 804s described above, the user USR may selectably click a body style selector button 304 to a “Sedan” and lock the selection 324. Similarly, the user USR may selectably click a body style selector button 304 on another slave interface 804s to a “Convertible” and lock the selection 324. For such a synchronizable interface 300u having six slave interfaces 804s, the user USR can therefore synchronize common features, e.g. all having a red exterior and black tire color, with other specific features called out across each of the slave interfaces, e.g. such as but not limited to body styles, interior colors, and/or other options, along with calculated prices, and/or estimated availability. The user can therefore operate the synchronizable interface 300u for any of:
clicking a selector button 304 on the master 804m, wherein all the images change;
locking 324 a selector button 304 on the master 804m, wherein all the slave images lock 324;
clicking a selector button 304 on any slave 804s, wherein just that slave image changes; and/or
locking 324 a selector button on any slave 804s, wherein just that slave feature is locked 324.

In various embodiments of the selective interface system 300, such as but not limited to the synchronizable interface 300u seen in FIG. 39, the position of one or more feature selectors 304 for showing a selectable characteristic may preferably be expressed in a quantifiable value, such as but not limited to any of degrees, clock hour positions, and/or radians. For example, in the synchronizable interface 300u seen in FIG. 41, different button selectors 304 may have:
a value of 45 associated with an exterior color selection of “Red”
a value of 85 associated with a tire color selection of “Black wall”; and/or
a value of 27 associated with a Body Type selection of “Coupe”.

FIG. 42 is a schematic view 820 of an alternate embodiment of a selection interface system 300v, having one or more button selectors 304, e.g. 304a-304k for any of controlling the characteristics of a typeface or font 824, controlling the characteristics of one or more passages of text, or establishing or modifying default styles that can later be selected by a user USR, e.g. such as for style sheet selection within a page layout program. For example, the button selectors 304 may be operable for selection of any of height, color, serif length, boldness, slant angle, and spacing of a font as shown by a displayed letter or word or paragraph. While the button selectors 304 may preferably control text in a manner similar in pull down menus, the feature selectors may preferably readily provide a wide spectrum of control within an intuitive interface 300v. For example, a user USR may readily control text size, leading and kerning with real-time scaling as shown within the display region 308, with coarse as well as fine tuning.

FIG. 43 is a schematic view 840 of an alternate embodiment of a selection interface system 300w, wherein one or more buttons 304, e.g. 304a-304k, control the properties, selection and/or arrangement of objects or articles 844 in two dimensional or three dimensional space, and/or relationships between objects. For example, a user USR may specify any of:
the length of an arm 844;
the position of the arm 844;
what is located at the ends of the arm 844, e.g. a cable hanging down, a pointed stick, etc.;
what is located below the arm 844, e.g. a bucket, a snow cone, etc.; and/or
what is located in the space under the arm 842, e.g. a dump truck, a basketball hoop, etc.

The selection interface system 300w allows objects to be described and/or moved spatially in relation to other objects. For example, a user USR may operate a button 304 to move an object from the foreground through the middle ground toward the background. As well, the selection interface system 300w may preferably allow a user to control and/or modify the characteristics of one or more objects, such as for any of color, size, motion, position, and/or movement.

In some embodiments, the selective interface system 300 may control the position of an object in space by choosing the coordinates of the object. For example, a camera may be located at X32, Y12, and Z66, while the camera lens is pointed at an object at X88, Y33, and Z744. In this example, as the user USR operates a button 304 for movement of the camera in the X-direction, the button 304 may stop when it gets to X88, because that is as far as it can actually logically move, as the camera or virtual camera arrives at a target object.

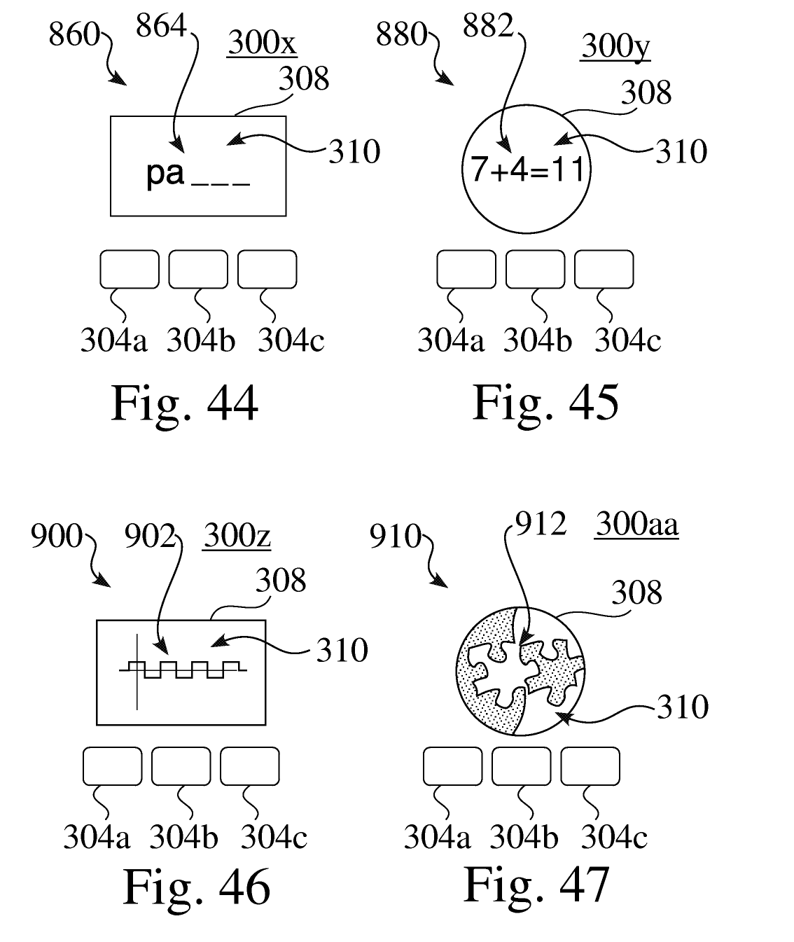

FIG. 44 is a schematic view 860 of an alternate embodiment of a button interface system 300x, wherein one or more button selectors 304, e.g. 304a-304c control the selectable characteristics of a portion of text 864, e.g. such as but not limited to a word, a phrase, or a sentence. For example, button selectors 304 may select any of:
how many letters;
first letter;
prefix, suffix;
what language, e.g. English, Spanish.

The selection interface system 300x may include entry of all possible characters, or may limit selection to letter combinations that are considered to be allowable, e.g. corresponding to nodes 414, such as by discarding non-logical combinations, e.g. combinations that do not correspond to nodes 414. For example, FIG. 44 shows the first two letters “pa” of a five letter word, wherein logical combinations that correspond to nodes 414 may allow continued entry of letters associated with the words “paint” or “party”. The selection interface system 300x may also provide definitions for entered words, and may also provide one or more feature selectors to suggest related words, synonyms, and/or antonyms.

FIG. 45 is a schematic view 880 of an alternate embodiment of a selection interface system 300y, wherein one or more button selectors 304, e.g. 304a-304c, control the selectable characteristics of variable parts of a mathematical equation 882. For example, a first button selector 304a may be used to enter a first number, a second button selector 304b may be configured for entry of an operator, e.g. +, −, *, or /, and a third button selector 304c may be configured for entry of a second number. As seen in FIG. 45, the selection interface system 300y may readily allow entry of the equation 7+4=11. In this example, changing the second button selector 304b from a “+” to a “−” would change the equation to 7−4=3.

FIG. 46 is a schematic view 900 of an alternate embodiment of a selection interface system 300z, wherein one or more button selectors 304, e.g. 304a-304c control the selectable characteristics of a waveform 902, such as to vary the characteristics of frequency, and amplitude, wherein the selectable characteristics may preferably be based upon allowable nodes 414. For example, the selection interface system 300z may be used either to display a virtual, i.e. calculated, waveform, or may be used for selective control of a real waveform, e.g. a square wave 902 at 60 hz with 120 volts. In some embodiments, the selection interface system 300z may preferably provide selection and/or control for other wavelengths, such as for but not limited to sound, RF, light. lasers, and/or x-rays. While some embodiments the selection interface system 300z may provide variable control for any waveform parameter, other embodiments of the selection interface system 300z may limit selections available through the button selectors 304 to possible choices, e.g. corresponding to nodes 414, thus avoiding impossible, impractical, undesirable, or unallowable combinations.

FIG. 47 is a schematic view 910 of an alternate embodiment of a selection interface system 300aa, wherein one or more button selectors 304, e.g. 304a-304c select, control, and/or determine a set 912 of matchable characteristics. For example, as seen in FIG. 47, one or more existing pieces of a puzzle are located on the left side of a screen 310. A user USR can change one or more settings on the button selectors 304, such as to identify features or characteristics of an unknown “next” piece, e.g. by building an image to match an image, and/or manipulate known pieces that may be used to match the puzzle, until a match is found. The selection interface system 300aa may be implemented for a wide variety of applications, such as for but not limited to design, chemical engineering, medicine, education, and/or recreation, e.g. games or puzzles.

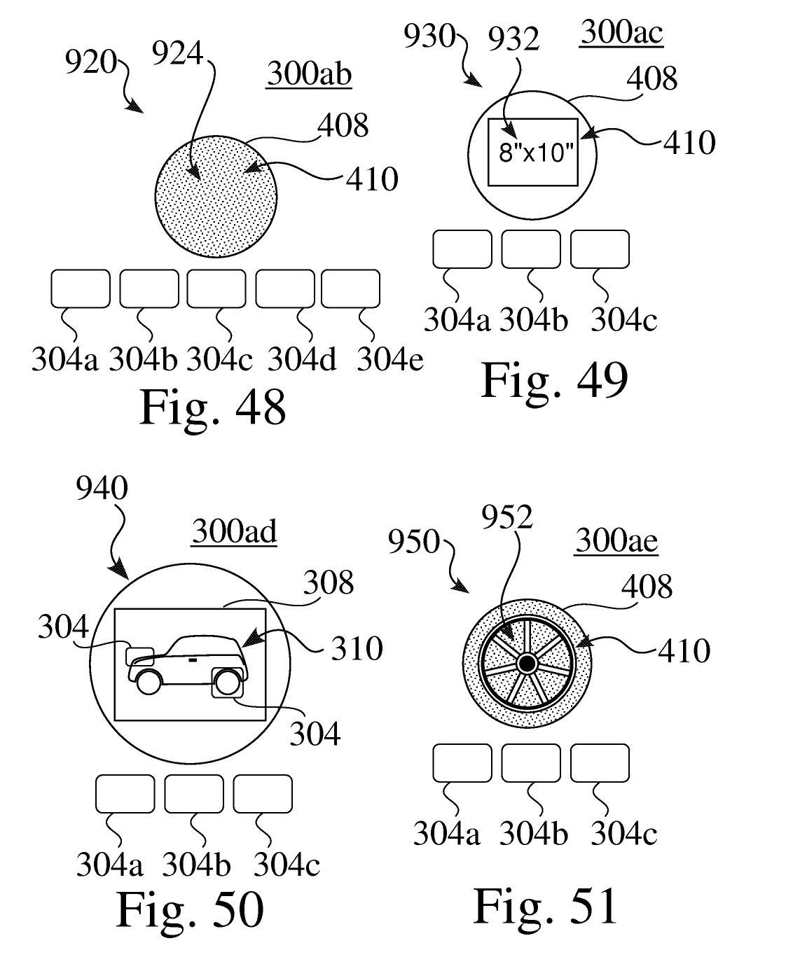

FIG. 48 is a schematic view 920 of an alternate embodiment of a selection interface system 300ab, wherein one or more button selectors 304, e.g. 304a-304e, select, control, and/or modify colors 924, such as through selection of a large variety of visual characteristics. The exemplary embodiment 300ab seen in FIG. 48 may provide controls such as:
a first button selector 304a: color, e.g. selection of basic color value
a second button selector 304b: Lightness/Darkness, e.g. selection from a series of the lightness/darkness levels);
a third button selector 304c: saturation level;
a fourth button selector 304d: blurry to sharp; and
a fifth button selector 304e: glowing edges, e.g. none to wide.

FIG. 49 is a schematic view 930 of an alternate embodiment of a selection interface system 300ac, wherein one or more button selectors 304, e.g. 304a-304c, may preferably be used to select size 932, such as for selection of a specified size of an object, or for selection of a specific object from a variety of object having different possible sizes. For example, a user may preferably select from different sizes 932 of standard photographic prints, e.g. 4 inch by 6 inch, 8 inch by 10 inch, or 11 inch by 14 inch, such as corresponding to allowable nodes 414. In another example, a user may preferably display an image 310 corresponding to any of a big car, a medium sized car, or a compact car.

FIG. 50 is a schematic view 940 of an alternate embodiment of a selection interface system 300ad, wherein one or more main, i.e. outer, button selectors 304, e.g. 304a-304c may preferably be used to determine a first selection, such as resulting in a primary image 310 within a primary display area 308. For example, as seen in FIG. 50, a user USR may preferably choose a particular vehicle model, wherein an associated image 310 is presented within display 308.

As also seen in FIG. 50, additional feature selectors 304, such as surrounding features within the image, and/or possibly having further presentable images 310, allow hierarchical selection of specific features. In the example shown in FIG. 50, one or more button selectors 304 are located over the engine compartment, wherein a user may preferably allow user selection of power plant characteristics, e.g. such as but not limited to power, efficiency, alternate fuel, electric or hybrid options, and/or materials. Similarly, one or more embedded button selectors 304 may be located over a battery compartment for a selected electric vehicle, wherein a user may select battery characteristics, such as but not limited to size, power, Ni Cad or Zinc, plug-in vs. welded in place, and/or lifetime rating.

The selection interface system 300ad therefore provides one or more specific button selectors 304 to be located within an image 310 associated with a general feature selector 304, such as to further refine an object 310 that is chosen by a more top level feature selector 304. The user USR can therefore navigate downward to make selections in regard to objects that have multiple levels of selectable characteristics, or upward to make more general selections 304.

FIG. 51 is a schematic view 950 of an alternate embodiment of a selection interface system 300ae, wherein a hierarchy 952 may preferably be established between button selectors 304, whereby the characteristic associated with a button selector 304 may preferably be selected by other buttons 304. For example, for the design or specification of a vehicle, many characteristics are commonly used to define the vehicle, such as but not limited to body style, engine type, exterior color, interior material, interior color, and wheel type. In the exemplary embodiment 300ae shown in FIG. 51, an first button selector 304a may be turned to select what a second button selector 304, e.g. 304b, controls. For example, if the first button selector 304a is turned to wheel type, the second button selector 304b reflects choices appropriate to different possible selections of wheel type, e.g. such as but not limited to steel, 17 inch five spoke alloy, or 18 inch 7 spoke gray anodized alloy.

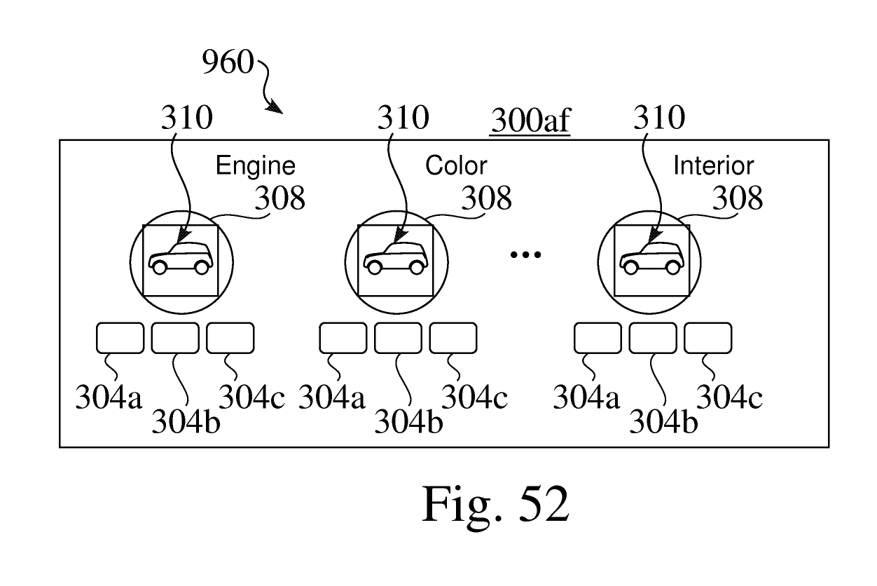

FIG. 52 is a schematic view 960 of a cascading selection interface system 300af having a plurality of sets of button selectors 304, e.g. 304a-304c, wherein each of the sets of feature selectors 304 have an identical image 310, while each set of buttons controls a single characteristic in all of the images 310. For example, in the exemplary embodiment seen in FIG. 52, the three sets of button selectors 304 are labeled for selection of “Engine”, “Color”, and “Interior”. While the user USR controls specific selectable aspects of the vehicle through a designated set of feature selectors 304, the resultant image 310 is shown in all of the associated display areas 308. Therefore, if any selection results in a change to the image 310, the change is updated in all of the images. The user

USR may rapidly make changes to the selection, using the plurality of sets of button selectors 304.

While the selection interface structures, systems, and methods described herein with reference to button selectors within a user interface, the structures, systems, and methods may alternately be implemented through a wide variety of selectable items, shapes, or structures, such as but not limited to knobs, rings, slide controls, or other actuators. As well, selection interface structures, systems, and methods described herein may alternately be implemented through mechanical structures and systems.

Although the invention is preferably described herein with reference to the preferred embodiment, one skilled in the art will readily appreciate that other applications may be substituted for those set forth herein without departing from the spirit and scope of the present invention. For example, the invention is readily practiced with any type of product or service. Accordingly, the invention should only be limited by the Claims included below.

1. A computer implemented selection interface system, comprising:
a database comprising a stored image of an item and information that corresponds to a plurality of one or more selectable characteristics that each comprise a set of parameters that modify the appearance or features of the item;
an image window; and
a processor configured to effect the display at least one button selector, wherein the button selector is uniquely linked to one of the selectable characteristics of the item and operable to select a corresponding one of the set of parameters associated with the one of said characteristics;
wherein the processor is configured to effect the display of an image within the image window that corresponds to the item as modified by the selected parameters associated with the selected characteristics of the item; and
wherein the image that corresponds to each parameter selected from each selected characteristic is retrievably displayable within the image window.

2. The selection interface system of claim 1, wherein the processor is further configured to provide a selection lock associated with at least one of the button selectors and operable to lock a selected parameter within a selectable characteristic, wherein only items that meet a locked parameter are available for presentation to a user within the image window.

3. The selection interface system of claim 2, wherein the selection lock comprises any of a firm lock to prevent any change to a selection or a flexible lock that allows a change if the user is insistent.

4. The selection interface system of claim 2, wherein the selection lock may provide any of popping between allowable positions, or freezing at an allowable position.

5. The selection interface system of claim 1, wherein at least one of the button selectors is located any of surrounding the image window, inside the image window, or outside the image window.

6. The selection interface system of claim 1, wherein at least one of the button selectors provides means for advancing through a sequence of possible selections, wherein each of the possible selections has a corresponding image.

7. The selection interface system of claim 6, wherein the means for advancing through the sequence of possible selections comprises any of random movement or sequential movement.

8. The selection interface system of claim 1, wherein at least one of the button selectors further comprises means for indication of selectable characteristics, wherein the indication means comprises any of text, a color, a shape, or an icon.

9. The selection interface system of claim 1, further comprising:
means for saving any of images or settings that correspond to selected positions of at least one of the button selectors.

10. The selection interface system of claim 1, wherein the processor is configured to effect the display of a plurality of sets of at least one button selector, each of the sets having an associated image window, wherein user selection for the sets is associated with any of a feature in common or a feature in combination between each of the sets.

11. The selection interface system of claim 1, further comprising:
means for transmitting any of an image or settings of at least one of the button selectors to another device.

12. The selection interface system of claim 1, wherein the processor is further configured to provide analysis of any of an image or content, and to determine position of at least one of the button selectors to correspond to the analyzed content.

13. The selection interface system of claim 1, wherein the at least one button selector comprises a plurality of button selectors, and wherein at least two of the button selectors further comprise a relationship there between.

14. The selection interface system of claim 1, wherein at least one the button selectors further comprises any of
means to prevent movement;
means for any of fine or coarse movement between selectable positions;
means for determining a selected position based upon a threshold of selection; or
means for ratcheting between selectable positions;

15. The selection interface system of claim 1, wherein at least one of the button selectors is rearrangable by a user.

16. The selection interface system of claim 1, wherein at least a portion of the image that is retrievably displayable within the image window is touch sensitive to initiate access to at least one of the button selectors.

17. The selection interface system of claim 1, wherein any of the image that is retrievably displayable within the image window or video content that is associated with the at least one button selector is linked to any of a process or task.

18. The selection interface system of claim 1, wherein a plurality of selection interfaces are synchronizable with respect to each other.

19. The selection interface system of claim 1, wherein the position at least one of the button selectors comprises a quantifiable value.

20. The selection interface system of claim 1, wherein at least one of the button selectors controls any of the characteristics of any of a typeface or font, the characteristics of one or more passages of text, or the characteristics of a text layout style template.

21. The selection interface system of claim 1, wherein at least one of the button selectors controls any of a property of an object, a selection of object, an arrangement of an object, a positions of an object, a relationship between objects, or selectable characteristics of at least a portion of text.

22. The selection interface system of claim 1, wherein at least one of the button selectors controls selectable characteristics of one or more parts of any of a mathematical equation, or a waveform.

23. The selection interface system of claim 1, wherein at least one of the button selectors is configured for any of selection, control, or determination of any of matchable characteristics, color, or size.

24. The selection interface system of claim 1, wherein at least one of the button selectors is configured for provide hierarchical control of at least one of the other button selectors.

25. A method, comprising the steps of:
providing an interface comprising
a processor,
a database comprising a stored image of an item and information that corresponds to a plurality of one or more selectable characteristics that each comprise a set of parameters that modify the appearance or features of the item,
an image window, and
at least one button that is displayable within the image window;
configuring the processor to effect the display of the at least one button within the image window, wherein the button is uniquely linked to one of the selectable characteristics of the item and operable to select a corresponding one of the set of parameters associated with the one of said characteristics; and
configuring the processor to effect the display of an image within the image window that corresponds to the item as modified by the selected parameters associated with the selected characteristics of the item;
wherein the image that corresponds to each parameter selected from each selected characteristic is displayable within the image window.
